(19) United States
(12) Patent Application Publication
(10) Pub. No.: US 2006/0227920 A1
(43) Pub. Date: Oct. 12, 2006

(54) Hybrid stoichiometric analysis and imaging using non-thermal and thermal neutrons

(76) Inventor: Bogdan C. Maglich, Lake Forest, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/295,746

(22) Filed: Dec. 6, 2005

Related U.S. Application Data
(63) Continuation of application No. 09/788,736, filed on Feb. 20, 2001.
Application No. 09/788,736 is a continuation of application No. 09/265,043, filed on Mar. 9, 1999, now abandoned.
Application No. 09/265,043 is a continuation-in-part of application No. 09/252,359, filed on Feb. 17, 1999, now abandoned.
(60) Provisional application No. 60/075,037, filed on Feb. 18, 1998.

(51) Int. Cl. G21G 1/06

(52) U.S. Cl. 376/158

(57) ABSTRACT

An apparatus and method for analyzing and imaging chemical compounds within a test subject uses subatomic particle activation. The test subject (and chemical compounds contained therein) is irradiated by non-thermal neutrons, thereby generating thermal neutrons within the test subject and stimulating the emission of gamma rays. Gamma ray detectors detect the emitted gamma rays and energy signals derived from the gamma ray detectors are filtered to eliminate non-relevant spectral artifacts.

### CLAIM OF PRIORITY

The present application is a continuation from U.S. patent application Ser. No. 09/788,736, filed Feb. 20, 2001, which is a continuation from U.S. patent application Ser. No. 09/265,043, filed Mar. 9, 1999, which is a continuation-in-part from U.S. patent application Ser. No. 09/252,359, filed Feb. 17, 1999, which claims priority to U.S. Provisional Patent Application No. 60/075,037, filed Feb. 18, 1998.

### BACKGROUND OF THE INVENTION

1. Field of the Invention

The present invention relates to the field of chemical compound detection and analysis, specifically to the detection and identification of explosives, nerve agents, contraband, and other chemical compounds using subatomic particle activation.

2. Description of the Related Art

The manifold societal problems associated with unexploded antipersonal (“AP”)/anti-vehicular land mines and chemical weapons are well known and documented. Such problems include, inter alia, the inadvertent detonation of such devices by an unsuspecting civilian population often times many years after the cease of hostilities. As of the late twentieth century, vast portions of the surface of the earth are infested with such devices and therefore rendered largely unusable.

In addition to land mines, significant stockpiles of unexploded chemical weapons in the form of artillery shells, rockets, grenades, and other warheads exist. These weapons contain a variety of highly destructive and potentially lethal compounds such as Sarin, and often bear no markings or means of identification of their contents thereby making disposal highly inefficient and dangerous.

Furthermore, large amounts of chemical contraband (e.g., illicit drugs such as cocaine, heroin, marijuana, and PCP, or alcohol) are produced and distributed throughout the world on a daily basis. These substances result in a host of deleterious effects on society in general including increased health care and rehabilitation costs as well as constant monitoring, surveillance, and intervention by law enforcement agencies.

Existing techniques for detecting, physically locating, and analyzing the aforementioned chemical compounds are marginally effective at best. A variety of different techniques such as X-ray analysis, magnetic resonance imaging (MRI), chemical “sniffers”, and visual inspection have been employed to date, yet all suffer from one significant disability or another, thereby greatly reducing their efficacy. For example, X-ray techniques can only provide information about an object's shape or location, and are not useful in large area searches (such as for land mines buried in the field or searches of large containerized cargo). Furthermore, such techniques require the subsequent use of intrusive means to determine if the identified substance is dangerous or not, thus resulting in a very high proportion of “false alarms.” Chemical sniffers are effective under certain limited circumstances, but can be easily defeated through proper sealing of the chemical compound in a non-permeable container, and are also impractical for use in many applications. Recently, more promising methods of detection and analysis using nuclear radiation (including so-called “fast neutron activation” or FNA techniques, such as described in U.S. Pat. No. 5,098,640, “Apparatus and Method for Detecting Contraband Using Fast Neutron Activation”) have been developed, yet these methods still suffer from a number of problems of their own, including poor spatial and gamma ray spectral resolution, great size, weight, and complexity. One significant problem related to these systems concerns the use of prior art subatomic particle coincidence circuits, which operate on the principle of detector-to-detector (or counter-to-counter) coincidence. This approach necessitates an analysis of the entire gamma spectrum generated by the counter, thereby requiring a tremendous signal processing capability to analyze even a modest number of detection events per unit time. The net result is very long irradiation/counting times (and correspondingly lower incident particle flux), as well as reduced chemical identification accuracy and confidence. Additionally, poor energy resolution of the scintillation detectors used in these systems has hampered the identification of specific spectral artifacts. These disabilities are discussed in greater detail in the following paragraphs.

Chemical Detection and Identification Using FNA-Induced Gamma Rays

There are two primary requirements for the quantitative chemical detection of explosives and other contraband substances using gamma rays: (i) the ability to resolve gamma ray energy precisely (approximately 0.5% or better resolution required); and (ii) the ability to temporally resolve gamma ray events (approximately 3 nanosecond and better resolution required). Prior art FNA devices have characteristically opted for good time resolution (typically 1-2 ns), at the expense of energy resolution. For example, a typical prior art Sodium Iodide scintillation detector has an energy resolution on the order of 10%. Because of this comparatively poor energy resolution, prior art contraband detection devices based on gamma ray spectrum analysis are not able to determine quantitative elemental composition of the interrogated object. Rather, they can detect only the presence (or dominance) of certain elements that are potentially indicative of contraband, thus providing an ‘alert’ signal. This alert signal in turn requires intrusive inspection of the interrogated object, and results in a false alarm rate which, while reduced from that of X ray contraband detectors, is still quite high (over 90% by some estimates). In contrast to scintillation detectors, High Purity Germanium Detectors (HPGD) have an energy resolution on the order of 0.1-0.3%; however, their dead time, determined by their charge collection time, is roughly 200 ns. Such dead time was considered incompatible with the aforementioned requirement of high temporal resolution.

Another critical performance criterion of chemical detection systems is detection speed, or discovery time. For such a detection system to be practical, it must be able to detect and recognize a predetermined quantity of contraband in a short period of time. For example, detection of 1 Kg of explosive within about 1 second would practically allow for the use of the system in most any application. Electronically, this level of performance requires a high data accumulation rate: at least 10,000 gamma events must be fully measured and processed per second (after rejecting associated “noise”) in order to have a large enough statistical sample to recognize the explosive by gamma ray analysis. Prior art contraband detection systems using gamma rays have exhibited detection times on the order of 1 hour for 1 Kg of explosive, or 3,600 times longer than the desired 1 second previously described, thereby rendering them impractical for many applications. This poor detection time is generally caused by two independent factors; (i) the “dead time” of the gamma detector; and (ii) the “piling up” of coincidences when more than one pulse arrives within the resolution time, which causes accidental coincidences which are indistinguishable from the true coincidences. These factors are discussed in greater detail below.

“Dead Time”

The “dead time” of an HPGD is the charge collection time, typically 200 ns. This value implies an ideal (non-random) maximum counting rate for the detector of 5 million events per second (i.e., 1 second/200 E-09 seconds per event=5 E06 events). However, a practical maximum counting rate, or one taking into account randomness, is about 100 times lower; roughly 50,000 events per second, assuming the same energy resolution (i.e., 0.1%). Prior art detection systems have been restricted by these limits, since the dead time has heretofore been considered to be an intrinsic property of the detector.

“Pile-Up”

“Pile-up”, also known as the accidental coincidence rate between two detectors, may be represented by the following relationship:
Nₐ=tᵣ×CR₁×CR₂ (Eqn. 1)
where:
Nₐ=accidental coincidence rate
tᵣ=event resolving time
CR₁=instantaneous counting rate in detector 1
CR₂=instantaneous counting rate in detector 2
   Although Sodium Iodide has good resolving time (on the order of 3 ns), pile-up will begin to take place when the product of two counting rates reaches roughly 10⁸; that is, the random coincidence rate will be comparable to the true coincidence rate at that point, and quadratically exceed the true rate above that level. It can be readily shown that this corresponds to a neutron production rate of 1 E06 neutrons into 4π steradians (i.e., an entire sphere) per second which yields about 3,600 times less gamma rays than is required for the desired 1 second contraband recognition previously discussed. Hence, a detector system that operates at about 3,600 times the rate of prior art systems (while maintaining the accidental count level below a predetermined value, such as 10%) would be needed to produce a 1 second recognition time.

It is further noted that prior art detection systems utilize detector-to-detector coincidence circuitry (i.e., an event occurring at one detector is compared to an event occurring at another detector), which further exacerbates the aforementioned problems.

Hence, in sum, no systems or techniques presently in existence provide an effective, accurate, and safe method for the non-intrusive detection, location, or analysis of deleterious chemical compounds regardless of their physical location or container. A system and method is needed by which objects and areas may be rapidly and accurately examined using non-intrusive means to determine 1) the three-dimensional (i.e., “X, Y, Z”) or spatial location of suspect objects contained within, and 2) the chemical identity of the suspect object as an explosive, nerve agent, chemical weapon, or item of contraband.

### SUMMARY OF THE INVENTION

The present invention satisfies the aforementioned needs by providing an improved apparatus for the detection, location, and chemical-specific analysis of chemical compounds with the purpose of non-intrusive identification as either explosives, nerve agents, chemical weapons, and contraband, as well as a method of operating the same, with high energy, temporal, and spatial resolution, and high detection speed. Additionally, a system and method for the standardized measurement of the efficacy of this apparatus and other existing detection/analysis devices is disclosed.

In a first aspect of the invention, an improved chemical compound detection, retrieval, location, and analysis apparatus is disclosed. In a first embodiment of this apparatus, an excitation beam containing one or more atomic species is used to bombard one or more specially constructed targets, thereby generating streams of subatomic particles which emanate from the target(s) in substantially opposite directions. In the present embodiment, neutrons and alpha particles emanating from the target(s) (i.e., “tagged fast neutrons”) are utilized. The object or area being examined is exposed to the generated neutron flux, the energetic neutrons of which interact with the nuclei atoms (in this case carbon, nitrogen, or oxygen, though others may be chosen) of any explosives, chemical weapons/nerve agents, or contraband within the subject thereby generating prompt quanta in the form of gamma rays. One or more gamma detectors are located relative to the subject being examined to detect these emitted quanta, which are subsequently analyzed to identify the elemental atomic proportions resident in the test subject. Additionally, one or more scintillation (or comparable) detectors are placed within the solid angle of the alpha particle flux in order to detect alpha particles in coincidence with the gamma events detected by the aforementioned gamma detectors, thereby further permitting spatial positioning.

In a second embodiment of the aforementioned apparatus, individual atomic species resident in the charged particle beam are separated through the application of a magnetic field or electric field (“septum”) in order to permit the excitation of more than one target. In this embodiment, multiple (but spatially discrete) neutron and alpha particle streams are generated, thereby bombarding the subject being examined with neutrons from different relative angles. Alternatively, beam “separation” may be accomplished without any applied field by generating a spatially broad beam and having it intersect multiple targets. This use of multiple neutron/alpha streams (or a single broad beam) and corresponding alpha/gamma detectors permits an even more accurate spatial location of the organic compound within the test subject.

In another aspect of the invention, an improved chemical compound location apparatus and method is disclosed. Utilizing the general technique of particle induced prompt gamma emission described above, one or more gamma detectors are placed in known physical proximity to the test subject. One or more alpha particle detectors are placed in general proximity to the target(s) as well. The timing difference (nanosecond time frame) between the alpha particle detection event and the induced prompt gamma detection event provides a coarse determination of the axial (i.e., line-of sight or “Z-axis”) distance between the activated chemical compound and the target, based on known neutron and alpha particle velocities, circuit and detector-induced delays, and excitation beam pulse duration. Further refinement of the coarse axial position, as well as an off-axis (i.e., “X-Y”) position determination, are provided through multi-node geometric analysis of data provided by the aforementioned gamma detector array. Such multi-node geometric analysis may utilize any number of lines of position.

In a third aspect of the invention, an improved coincidence detection apparatus and method is disclosed. An array of alpha particle detectors is formed in general proximity to the neutron-generating target(s) previously described. By knowing the geometric relationship of each detector in the array to the associated target, individual prompt gamma events (relating to specific elemental gamma “lines” that are characteristic of certain “signature” elements associated with explosives) occurring in the test subject can be correlated with individual detection events within the alpha detector array, thereby fixing the spatial position of the gamma emitter within the test subject, and permitting a greatly enhanced rate of event processing due to parallelism.

In a fourth aspect of the invention, an improved gamma ray detection, gamma ray filtration, and analysis apparatus and method is disclosed. Germanium crystal detectors are used to detect prompt gamma events within the test subject. The Germanium detectors provide enhanced gamma energy resolution, thereby allowing discrimination of the multiple C:N:O (or other elements) spectral lines from the “background” of hundreds of other gamma lines. The high-resolution gamma spectrum is decomposed into a binary representation, with each line assigned a different binary value (“bin”) representing its gamma energy level. Known lines (bins) associated with carbon, nitrogen, and oxygen for the chosen type/energy of incident particle stream are then further processed, with other unrelated lines being filtered out. In this fashion, the computational burden on attached signal or data processing equipment is greatly reduced since only relevant C:N:O peaks survive the filtration stage.

In yet another aspect of the invention, an improved method for identifying chemical compounds using particle activation is disclosed. The filtered gamma detector output signal described in the preceding paragraph is input to a signal processing apparatus running an improved explosive/chemical weapon/nerve agent/contraband identification and classification algorithm. This algorithm is based on the well known “Dalitz Triangle,” and identifies the activated chemical compound (if it is an explosive, chemical weapon, nerve agent, or contraband substance) within the test subject through calculation of the relative proportions of C:N:O (or other elements) as provided by the filtered gamma spectra. Statistical weighting and error analysis may also be employed to evaluate the resultant data.

In a sixth aspect of the invention, quanta associated with the interaction of thermal neutrons and the atoms of illicit chemical substances (or other closely associated chemicals) are analyzed in order to provide an indicator or “flag” alerting the operator to the potential presence of the illicit substances. Specifically, a stream of fast neutrons is directed onto the subject being examined as described above. A portion of these fast neutrons are “auto-thermalized” or reduced in energy level by atomic interaction with the materials of the subject. Quanta, in this case gamma radiation, associated with the interaction of the thermalized neutrons and the illicit chemical (or associated chemicals) within the subject is detected and analyzed. In one embodiment chlorine atoms, whose presence is strongly correlated with the presence of both cocaine and heroin, is used as a flag. Gamma rays having an energy level falling within predetermined energy bands indicative of the activation of chlorine by thermal neutrons are used to generate a prompt alert signal for the operator. Parallel or sequential analysis of the emitted gamma spectrum resulting from fast neutron activation (as previously described) is also performed to further identify and/or locate the illicit substance.

In a seventh aspect of the invention, an improved system and method for measuring the efficacy (figure of merit) of a particle activation-based detection/analysis system and calibrating same is disclosed. A discovery time constant (Td) is mathematically defined which is a measure of the time required to perform a chemically specific identification of a certain mass of chemical compound at a certain distance from the particle source, and certain distance between the chemical compound and gamma detector(s), with a prescribed statistical confidence level about the relevant point on the aforementioned Dalitz triangle. A baseline system Td is then generated thereby providing a basis for comparison for actual data received from the operating system when analyzing specimens of varying mass under varying test conditions. The Td values measured under such varying test conditions are then used to generate correction factors for the system which are useful in calibration and field testing. Furthermore, experimentally generated values of Td for one system are then compared to those of another system in order to determine the relative efficacy of the two systems under various operating conditions.

### BRIEF DESCRIPTION OF THE DRAWINGS

FIG. 1 is a side view of a first embodiment of the chemical compound detection and analysis apparatus of the present invention.

FIG. 2a is a perspective view of the apparatus of the present invention adapted for use in examining airport baggage handling cars.

FIG. 2b is a perspective view of the apparatus of the present invention adapted for use on a land mobile vehicle.

FIG. 3 is a perspective view of a first embodiment of an alpha particle detector array according to the present invention.

FIG. 4 is a side view of a second embodiment of the chemical compound detection and analysis apparatus of the present invention, utilizing multiple targets and an applied magnetic field.

FIG. 5 is a side view of a third embodiment of the chemical compound detection and analysis apparatus of the present invention, utilizing multiple targets and a single, spatially broadened beam.

FIG. 6 is a perspective view of a dual-source neutron activation apparatus according to the present invention.

FIG. 7 is a perspective view of a fourth embodiment of the chemical compound detection and analysis apparatus of the present invention, as might be attached to a land-mobile vehicle useful for land mine or buried explosives detection.

FIG. 8 is a block diagram illustrating one embodiment of the gamma spectrum analog-to-digital conversion and filtration process of the present invention.

FIG. 9 is a prompt gamma ray emission spectrum obtained from a typical prior art fast neutron activation detection system.

FIG. 10 is a prompt gamma ray emission spectrum (background subtracted) obtained by irradiating a urea test specimen with fast neutrons and detecting prompt gamma emissions using a Germanium crystal detector gated at 40 ns.

FIG. 11 is a prompt gamma ray emission spectrum (no background subtraction) obtained by irradiating a urea test specimen with fast neutrons and detecting prompt gamma emissions using a Germanium crystal detector gated at approximately 6 ns.

FIGS. 12a and 12b are sample prompt gamma ray spectra showing the peak and three discrete bandwidths analyzed as part of one embodiment of the chemical identification method of the present invention.

FIG. 13 is a graph illustrating the method of gamma event rise time measurement according to the present invention.

FIG. 14 is a bar graph of a digitized spectrum showing the relative constituent elements and concentrations of several common chemical compounds.

FIGS. 15a and 15b are diagrams of the C:H:O and C:N:O Dalitz triangles, respectively, showing a variety of common chemical compounds.

FIG. 16 is a prompt gamma ray spectrum illustrating the chlorine “peaks” associated with the interaction of thermalized fast neutrons and chlorine atoms commonly present in cocaine muriate (in rice).

FIG. 17 is a block diagram of the method disclosed in the present invention for evaluating and calibrating FNA devices using the discovery time constant Td.

### DETAILED DESCRIPTION OF THE PREFERRED EMBODIMENT

Reference is now made to the drawings wherein like numerals refer to like parts throughout.

Detection, Location, and Analysis Apparatus

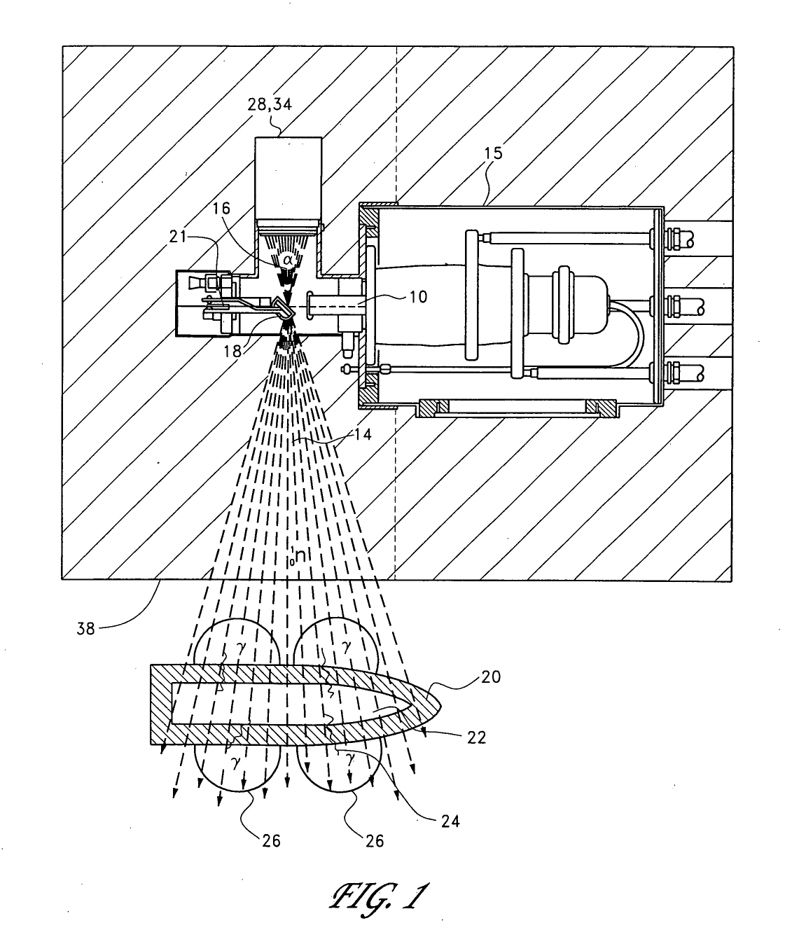

FIG. 1 shows a first embodiment of the particle detection and analysis apparatus of the present invention. As shown in the Figure, an accelerated beam 10 containing one or more subatomic species (here, various ionized isotopes of hydrogen including deuterium and tritium) are used to bombard one or more specially constructed targets 18, thereby generating streams of subatomic particles (fast neutrons 14 and alpha particles 16) which simultaneously, in pairs, emanate from the target(s) 18 in substantially opposite directions. A conventional or advanced charged particle accelerator of the type well known in the art, such as the Model A-711 accelerator manufactured by the MF Physics Corporation, is used as the source 15 although a variety of different such sources may be used with equal success. In the present embodiment, the source 15 is operated in a continuous direct current (i.e., DC) mode such that excitation particles are incident on the target(s) continually which may or may not be modulated into “long” (0.1 to 10 sec.) discrete time intervals, although other schemes may be used. In the present context, the term “long” is used with respect to the coincidence resolving times described later herein, which are on the order of 1 to 100 nanoseconds. It should also be noted that while neutrons and alpha particles are generated from the target(s) in the present embodiment, other subatomic particles or emissions with desirable properties may also feasibly be used to produce the desired result within the test subject. The object or area being examined 20 is exposed to the generated fast neutron flux 14, the energetic neutrons of which interact with the carbon, nitrogen, or oxygen bearing (C:N:O) molecules of any explosives, chemical weapons/nerve agents, or contraband 22 within the subject 20 thereby generating prompt quanta in the form of gamma rays 24 which are characteristic of C, N, and O and are know as “signatures” of the aforementioned substances. It is further noted that the energies of these gamma rays 24 have substantially discrete values. One or more high-resolution gamma detectors 26 of the type well known in the art are placed relative to the subject being examined 20 to detect these emitted quanta, which are subsequently analyzed to identify the molecules resident in the test subject. Additionally, one or more scintillation (or comparable) detectors 28 of the type well know in the art are placed within the solid angle of the alpha particle flux 16 in order to detect alpha particles in coincidence with the gamma events detected by the aforementioned gamma detectors 26, thereby permitting two separate determinations: 1) that of the gamma-alpha simultaneous timing (rejecting non-synchronous events), and 2) spatial positioning. High purity (80%) germanium detectors of the N-type (neutron resistant) produced by ORTEC Corporation are used as the gamma detectors 26 in the present embodiment. Note that while Germanium crystal detectors are preferred (as further described below), it can be appreciated that other types of high-resolution detectors, for example those utilizing Xenon, may be used to accomplish the desired functionality of coincident alpha and prompt gamma detection for both the timing and spatial location of the chemical compound within the test subject.

The targets 18 of the present embodiment are constructed of a scandium tritide layer deposited on a copper (Cu) substrate, both substances which are well known in the material sciences, the targets having the desirable property of generating a stream of neutrons (neutrally charged nucleons) and alpha particles (ionized helium nuclei) when properly excited by the incident deuteron/tritium ion beam 10. It can be appreciated, however, that other types of targets and materials may be used in this application.

Neutrons are created in the target(s) according to the following exemplary reactions:
₁H²+₁H³→₂He⁴+ₒn¹+14 MeV
₁H²+₁H²→₂He³+ₒn¹+3.27 MeV
₁H³+₁H³→₂He⁴+ₒn¹+ₒn¹+11.33 MeV
Note that the energy of the incident deuteron/tritium ion beam 10 must be sufficient to overcome any coulombic interaction with the positively charged nuclei of the target material atoms. Deuteron/tritium ion energies of 0.05 MeV or greater have been found sufficient for this purpose.

Fast neutrons having energies on the order of 14 MeV are utilized to bombard the test subject 18 in the present embodiment due to their desirable scattering properties (i.e., inelastic scattering with nuclei) and ability to penetrate significant thicknesses of common substances such as steel, soil, sand, lead, earth, and slabs of water up to approximately 50 cm in thickness (1/e interaction length). Note that the cross section (in mbams) for gamma production in C, N, and O by 14 MeV neutrons is nearly independent of the neutron energy at that energy level; thus, the relative concentrations of these elements can be obtained to a high degree of accuracy without knowing the actual collision energy. This is in contrast to the lower neutron energies of many prior art systems, which have cross sections which vary much more significantly with neutron energy, thereby making it practically impossible to calculate the relative chemical contributions without knowledge of the precise collision energy. Despite these considerations, however, it will be appreciated that neutron energy levels other than 14 MeV (and even multiple energy levels) may be used based in the present invention on the desired system operating characteristics.

The neutron and alpha particle beams 14, 16 released by the target are distributed spatially throughout a given solid angle φ (measured in steradians) which is related to the angle of incidence of the charged particle beam to the target, the axis of each beam (corresponding to the highest neutron or alpha particle flux) being substantially co-linear with the other, yet opposite in direction relative to the target 18 (see FIG. 1). Each target may be either fixed or independently steerable (adjustable) in relation to the excitation beam 10 and test subject 20 via a conventional electromechanical positioning device 21, although it can be appreciated that any variety of arrangements may be used. Such positioning devices may be manually controlled, or alternatively automatically controlled via inputs such as those from the signal processing components described later herein. In this fashion, the resulting neutron and alpha particle beams 14, 30 may be adjusted to provide the desired neutron/alpha flux in a given solid angle, such as for scanning purposes.

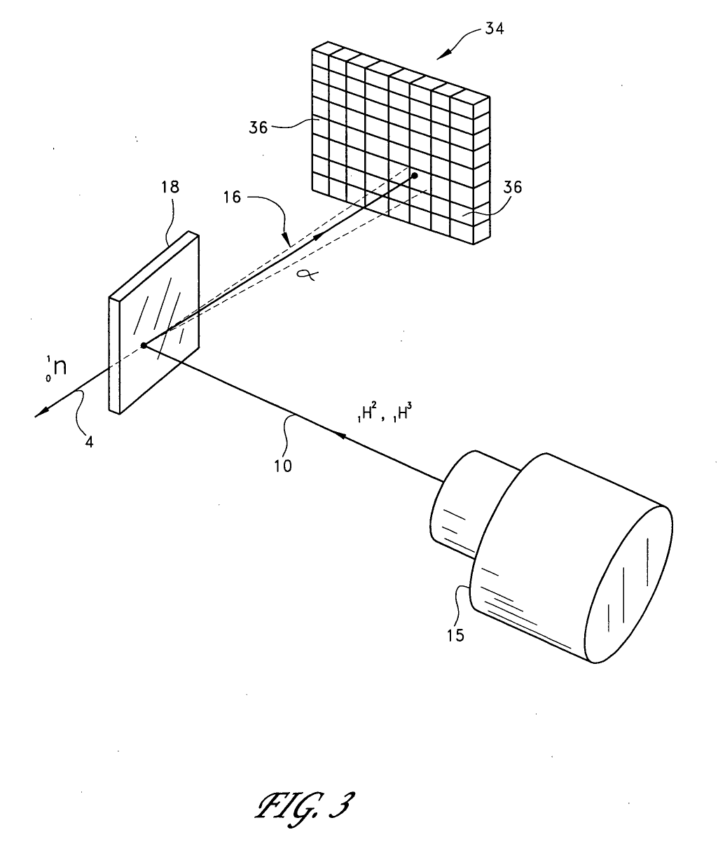

In the present embodiment, alpha particle detection is accomplished via an array 34 of scintillation or comparable detector elements 36 having a known spatial relationship to each other. FIG. 3 shows an exemplary configuration consisting of a square array (8×8) of 64 discrete detector elements. Each of the 64 detector elements is viewed by one photomultiplier (“PM”) tube or by one of the 64 “segmented anodes” built into one large PM tube, each anode acting as an independent counter. This array 34 is placed in a known position relative to the target(s) such that each detector element subtends a given solid angle φ with respect to its associated target 18. Accordingly, based on the substantially co-linear relationship between the fast neutrons and alpha particles emitted from the target upon excitation, individual alpha detection events can be directly correlated with the locii of the neutron-induced events occurring in the test subject within a similar but inverse solid angle (see FIG. 1).

It should also be noted that in the present embodiment, borated polyethylene elements 38 (or those constructed of comparable neutron absorbing or moderating material) are used to shield personnel and equipment adjacent to the apparatus from the deuteron/neutron/alpha radiation generated within the system, and further to collimate the neutron beam 14 generated by the target(s) if desired as shown in FIG. 1.

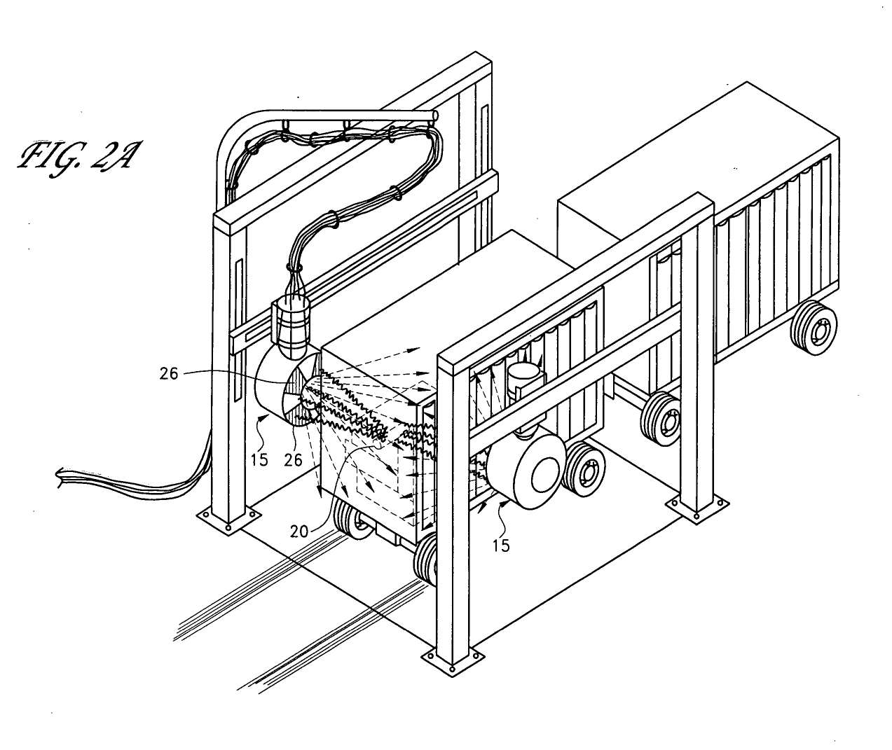

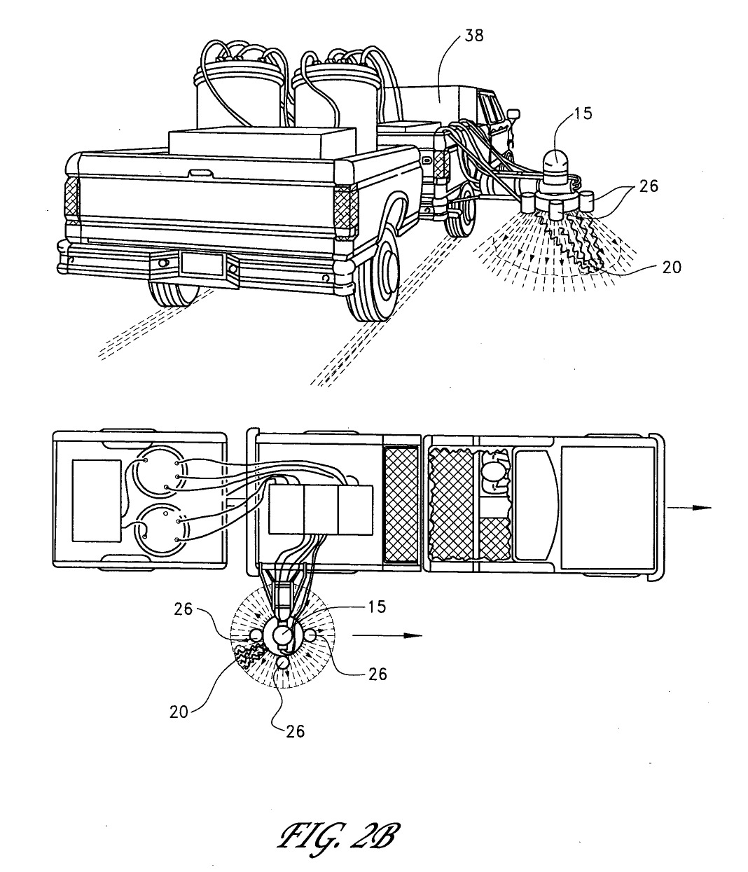

Note that the present embodiment (as well as those later discussed) may be adapted to a variety of different applications and geometries including, inter alia, land mine detection and identification, artillery shell analysis, or as shown in FIG. 2a, analysis of airport baggage carriers for contraband. In the context of detecting buried or otherwise shielded explosives such as land mines or artillery shells, the present invention may be readily adapted to a land mobile vehicle of the type well known in the mechanical arts (FIG. 2b) which is either controlled directly by an operator, or remotely controlled in order to facilitate surveying large portions of terrain with relative efficiency. It will be recognized that the greatly reduced detection time associated with the present invention (on the order of a few seconds) makes such land mobile applications feasible, whereas such applications were not feasible using prior art particle activation systems due to their comparatively long detection times (characteristically on the order of tens of minutes or more). Such a land mobile vehicle would ideally have the source(s) 15, target(s) 18, and detectors 26, 36 physically removed from the chassis of the vehicle, such as on an extensive boom or arm (not shown), so that sufficient distance between these components and the vehicle could be maintained and the chance of damage to the vehicle reduced, although other configurations are possible and within the scope of the present invention.

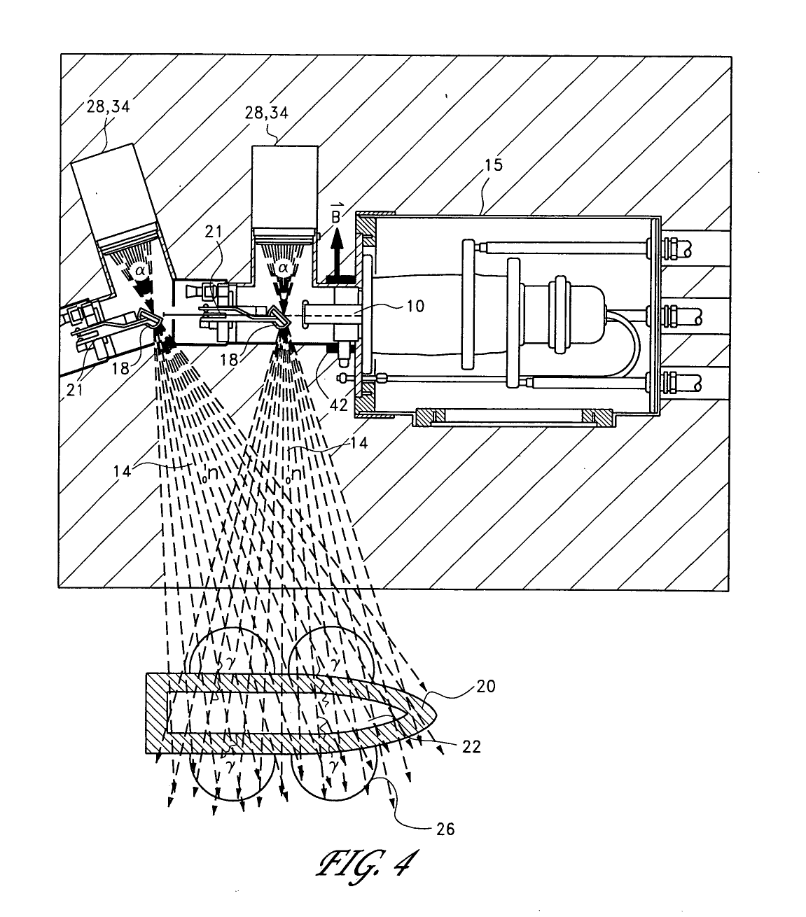

In a second embodiment of the aforementioned apparatus (shown in FIG. 4), individual atomic species resident in the excitation beam 10 are separated through the application of a magnetic field 40 induced along the beam path in order to permit the excitation of more than one target 18. Specifically, the excitation beam produced by the aforementioned source 15 contains a plurality of atomic species including deuterons and tritium ions, each having different atomic mass number. As is well understood in the physical sciences, a charged particle passing through a magnetic field experiences a deflecting force, the magnitude and direction of which is determined by the particle's charge and mass, and the strength and direction of the magnetic field vector at that given location. Hence, particles of different atomic mass but of the same kinetic energy can be deflected along curved paths of different radii utilizing the same magnetic field. In the present embodiment, two atomic species are deflected using a perpendicular magnetic field 40 in such a manner as to permit impact of the different species on two different targets 18. The magnetic field is generated through use of a conventional or superconducting electromagnet 42 of the type well know in the art which is placed in direct proximity to the excitation beam path 10, although other methods and arrangements (such as electrostatic depletion) may be utilized with equal success. The charged excitation particles strike two spatially disparate targets of the same construction as previously described, thereby permitting both resulting fast neutron beams 14 to be directed toward the same test object or area simultaneously. This “binocular” apparatus permits enhanced spatial resolution of the gamma-emitting chemical compound within the test subject via triangulation; i.e., the emission location is fixed by computing the intersection of two lines (or subtended solid angles) within the test subject 20. This way, the usual determination of the Z-axis coordinate by measuring time-of-flight of each neutron is avoided and precise X,Y,Z values are obtained directly. Spatial resolution on the order of 1 cm or less is practically achievable using, inter alia, the binocular apparatus of the present invention.

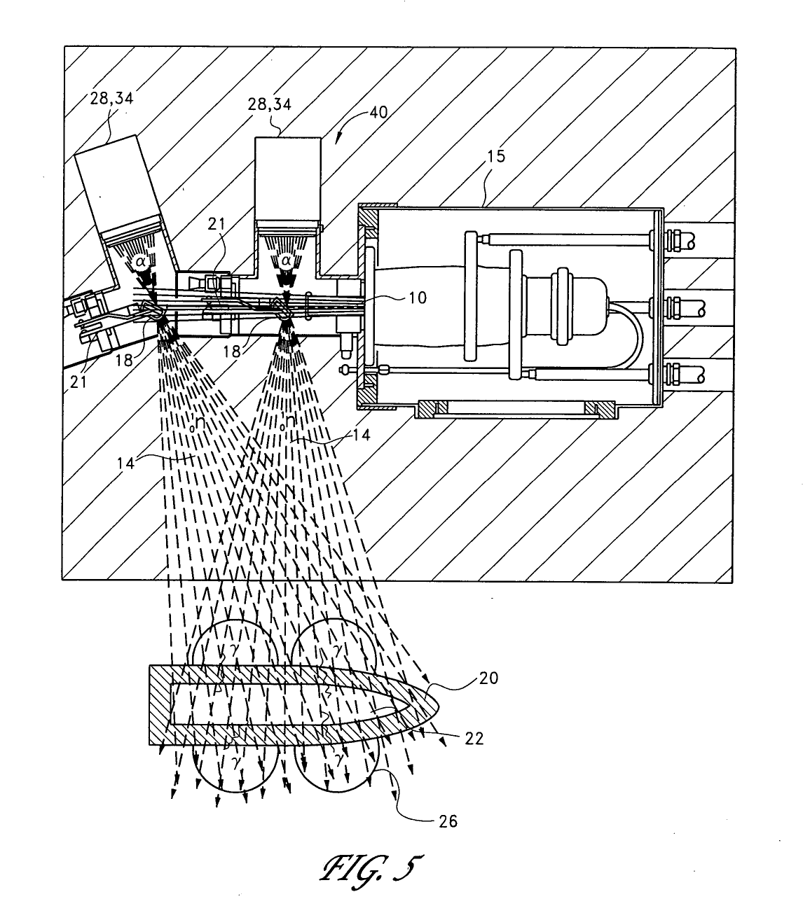

It should be noted that alternatively, the excitation beam 10 may be split into multiple beams and directed into multiple targets using (i) an electrostatic septum, as is well known in the field of particle physics, or (ii) by broadening the beam spatially and utilizing multiple targets to intersect a fraction of the beam, as shown in FIG. 5. Using these approaches, the beam 10 may be comprised of one or multiple species.

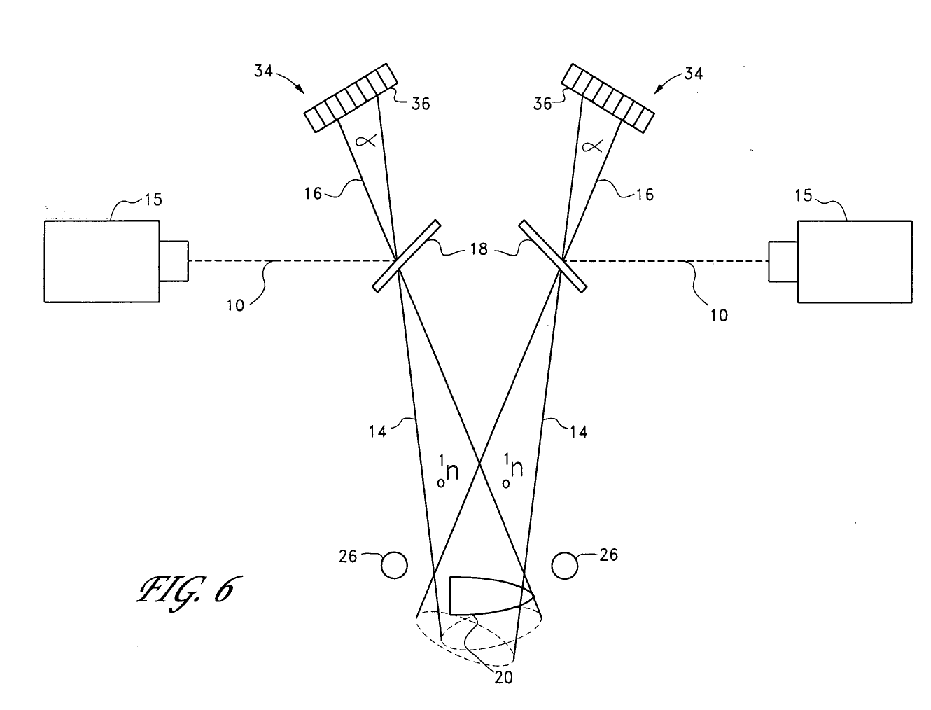

In yet another embodiment of the invention shown in FIG. 6, two or more deuteron sources 15 are utilized to excite a plurality of targets 18, thereby inducing the emission of neutrons for the targets. This embodiment obviates the need for the application of the aforementioned magnetic field 40 (and the supporting structure necessary to generate such field) or broad particle beam. The multiple deuteron sources 15 are physically placed so as to optimize the ability of the device to spatially locate the chemical compound(s) of interest within the test subject 20, and are similarly operated in either a continuous (“long”) or modulated mode (such modulated pulses being substantially coincident or staggered in time, depending on the desired properties of the system).

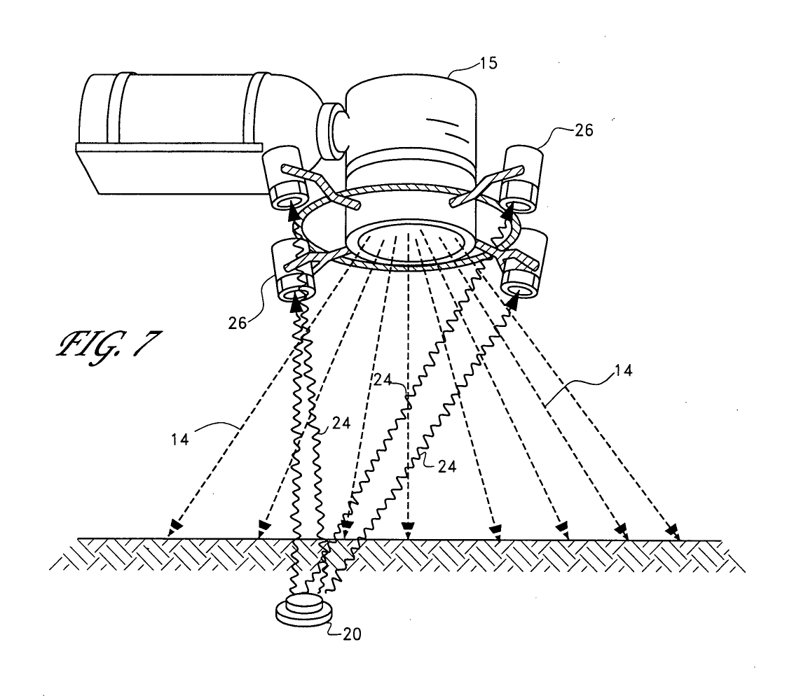

Referring now to FIG. 7, another embodiment of the chemical compound detection, location, and analysis apparatus of the present invention is shown. A plurality of gamma detectors 26 are placed in known physical proximity to the test subject, and one or more alpha particle detectors (not shown) are placed in general proximity to the target(s). The target is excited by a DC deuteron pulse of known duration (typically 0.1 to 20 sec.), and the timing difference between a given alpha particle detection event (or series of events) as detected by the alpha detectors 28 and the induced prompt gamma event(s) detected by the gamma detectors 26 is measured to provide a coarse determination of the axial (i.e., line-of sight, or “Z-axis”) distance 44 between the activated chemical compound and the target 18. Such determination is performed by a digital signal processor (or microprocessor) running an algorithm in the present embodiment; although other arrangements may be used. Known neutron and alpha particle velocities, electronically-induced detection delays, prompt gamma emission delays, and excitation beam pulse duration are considered in order to produce this coarse estimate. Further refinement of the coarse axial position previously calculated, as well as an off-axis (i.e., “X-Y”) position determination, are provided through subsequent multi-node geometric analysis (using any number of lines of position, such as triangulation) of data provided by the aforementioned gamma detector array 26. Specifically, by knowing the angular and spatial relationships of the gamma detectors to each other and the target, the location of a prompt gamma emitter (i.e., chemical compound) can be determined through analysis of the counting rate and/or timing differences between individual detection events. This arrangement also has the advantages of not having to measure neutron time-of-flight (TOF) or neutron emission/incidence angle.

### I. Coincidence Detection

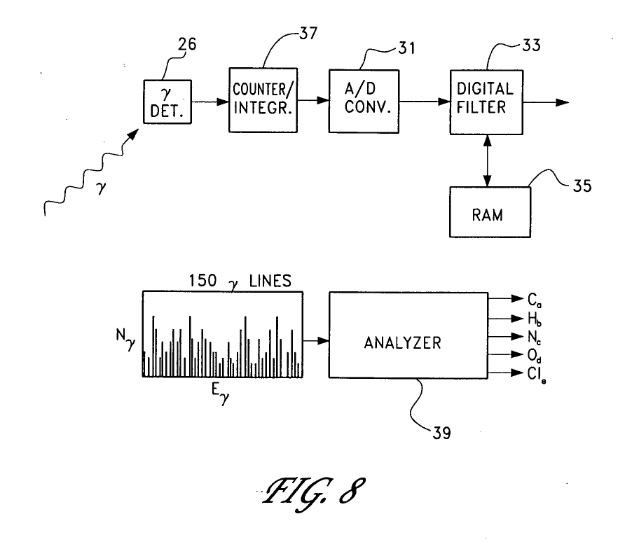

Referring now to FIGS. 3 and 8, an improved coincidence detection apparatus and method is described. An array of alpha particle detectors such as that shown in FIG. 3 and previously described herein is formed in general proximity to the neutron-generating target(s) previously described. Pre-selected individual gamma spectral lines (corresponding to the emission of prompt gammas from a given type of atom within the test subject) are electronically correlated with each alpha detector array element 36 by the analyzer 39 to form a plurality of parallel coincidence circuits. Specifically, gamma detection events remaining in the post-filtration gamma spectrum (FIG. 8) are correlated with alpha detection events for each alpha detector array element using a nominal 10 msec. gating window. In one embodiment, approximately twenty (20) different discrete gamma lines from one gamma counter 37 and detector 26 (corresponding to the emission lines of the elements of concern) are selected and electronically placed in coincidence with signals from each of the 64 elements of the alpha detector array 34. This arrangement produces a large number of parallel coincidence channels. For example, in the present embodiment, a set of four gamma detectors 26 and 64 alpha detector elements 36 are used. As will be described in further detail below, each of the 20 selected spectral lines is decomposed into three roughly 4 KeV bandwidth components, thereby creating 20×3=60 independent channels per gamma detector/counter. Since four detectors are used, 60×4=240 independent channels are associated with the gamma detector array as a whole. When correlated with the 64 alpha elements 36 in the alpha detector array 34, a total of 15,360 independent coincidence channels result. Contrast this with a prior art “detector-detector” coincidence system, which using the same 4/64 arrays, would produce only 256 independent channels. This highly parallel coincidence circuit structure of the present invention permits the processing of a substantially increased number of prompt gamma events, since only those events correlating to the desired twenty or so spectral lines (C:N:O in the present embodiment) need be correlated to events detected by the alpha array 34, and such events are processed with a high degree of parallelism. Accordingly, a higher incident neutron flux 14 (on the order of 10⁹ to 10¹¹ n/s-4 pi) may be used as compared to prior art systems using detector-detector coincidence (and maximum neutron fluxes on the order of 10⁶ n/s-4 pi), and significantly less time is ultimately required to identify and analyze a given compound under the same test conditions.

It will be recognized that precise gamma energy determination is important in the present invention in order to identify the parent atom of gamma rays chosen for analysis. Several factors influence the selection of gamma ray peaks and spectral lines used for the analysis. These factors include (i) gamma energy; (ii) cross section; (iii) cascade vs. photo-peak; (iv) proximity and overlap; and (v) single/double escape peaks. These factors are discussed in greater detail in Appendix A attached hereto. It will also be appreciated that the coincidence and detection circuitry of the present invention may optionally utilize corrections for noise and detector efficiency, one approach is described in Appendices B and C, respectively.

In a second embodiment of the coincidence detection apparatus of the present invention, 38,400 coincidence circuits (all accommodated by the signal processing capability of one signal processing IC of the type well known in the electronic arts) are formed. Specifically, the alpha detector array 34 is segregated into 640 discrete detector elements 36, and the output of the gamma detector(s) 26 is separated into 30 discrete energy bandwidths. Separation of the gamma detector output into bandwidths as described results in each gamma detector bandwidth acting as a separate detector electronically. Accordingly, with the 640-element alpha array 34 and a single physical gamma detector (30 “electronic” gamma detectors), 640×30=19,200 coincidence circuits may be formed. Lookup tables are used in conjunction with a standard random access memory (RAM) within the analyzer 39 of the present embodiment to facilitate rapid processing of this large number of coincidence circuits. In addition, each coincidence circuit in the present embodiment is provided a parallel coincidence circuit with an artificially imposed delay to account for the aforementioned “accidental” coincidences. This amounts to an additional 19,200 coincidence circuits. Hence, the total number of coincidence circuits used in this second embodiment is 38,400 (19,200+19,200).

Chemical Identification

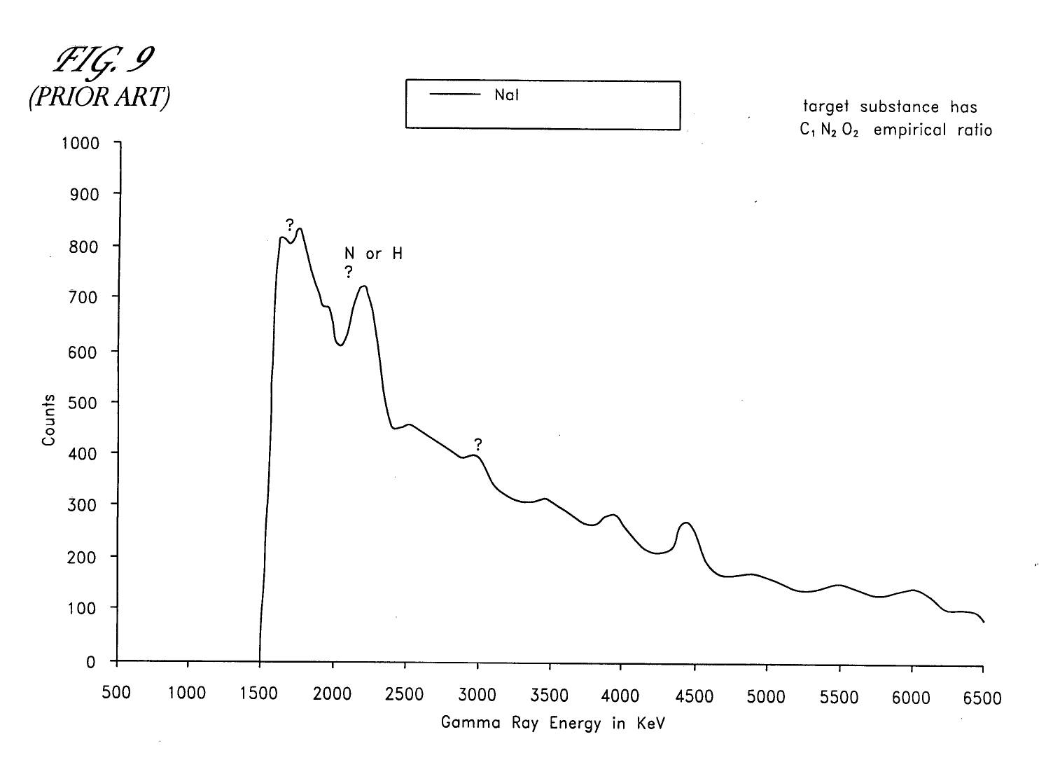

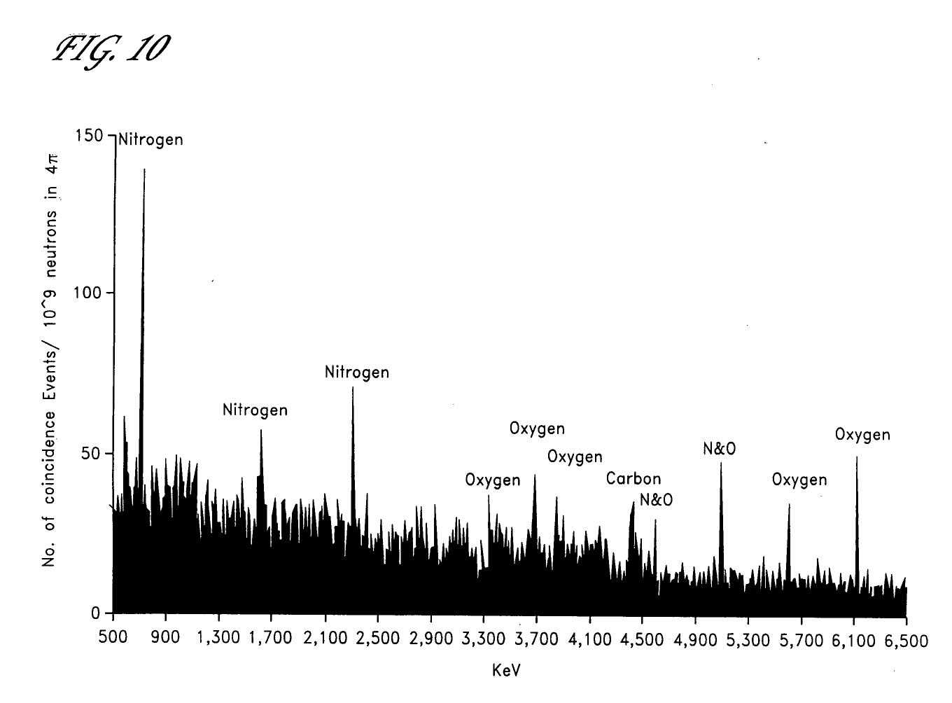

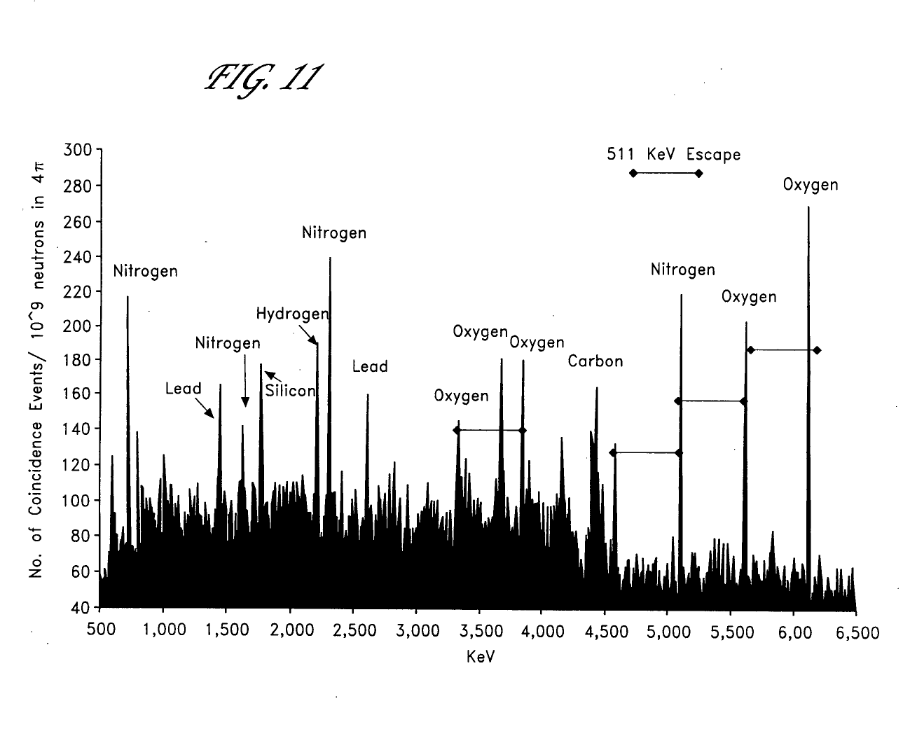

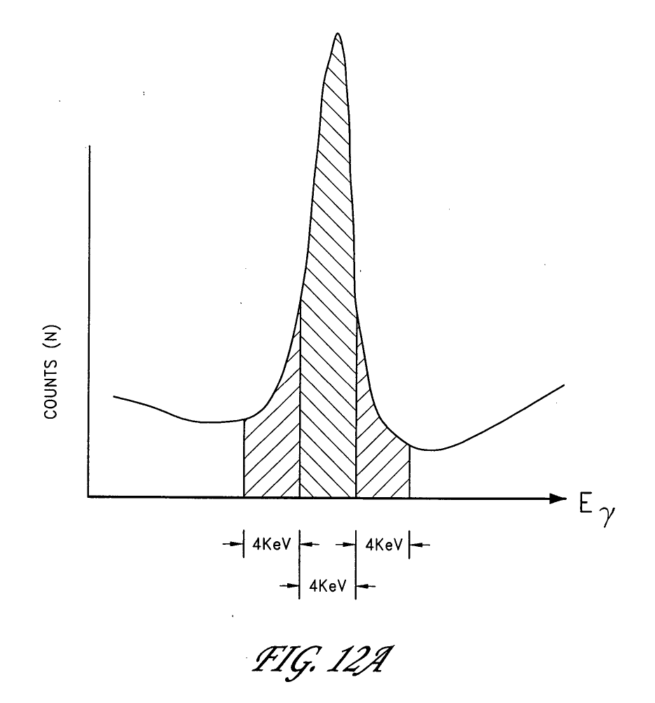

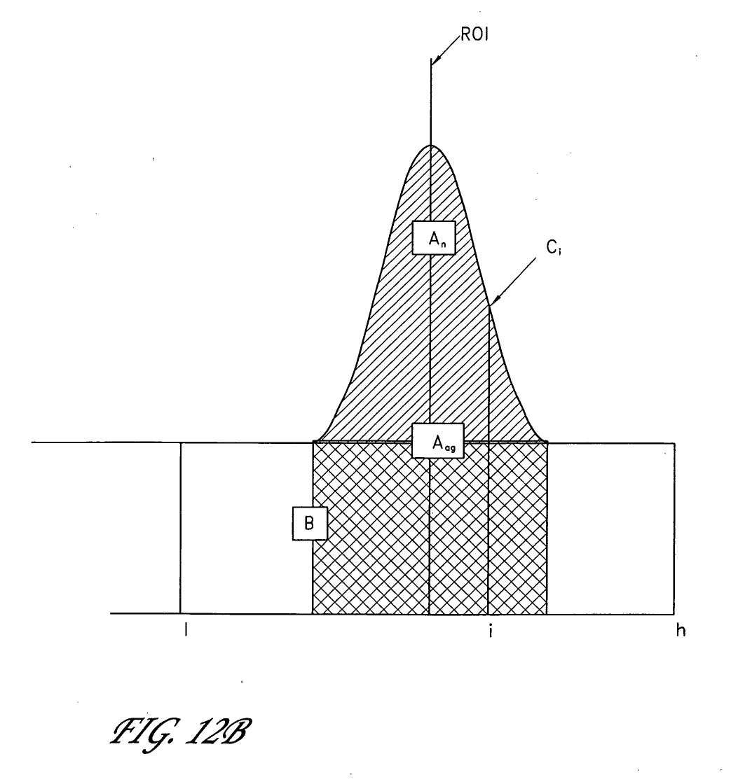

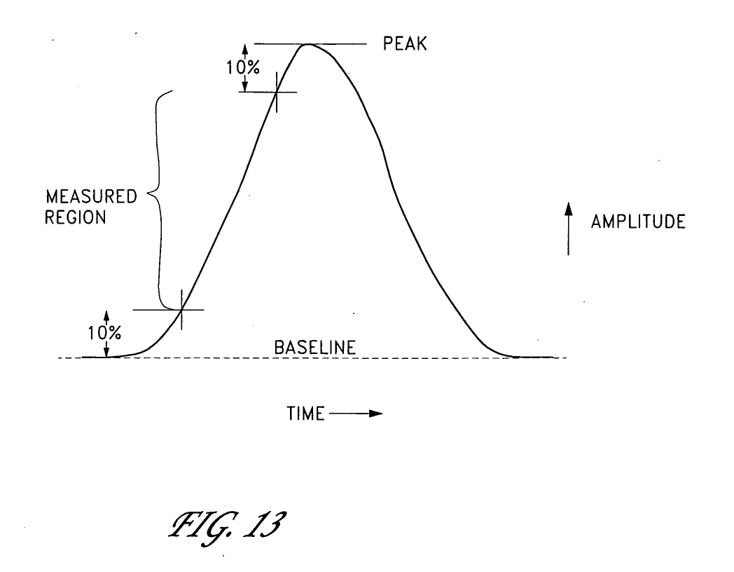

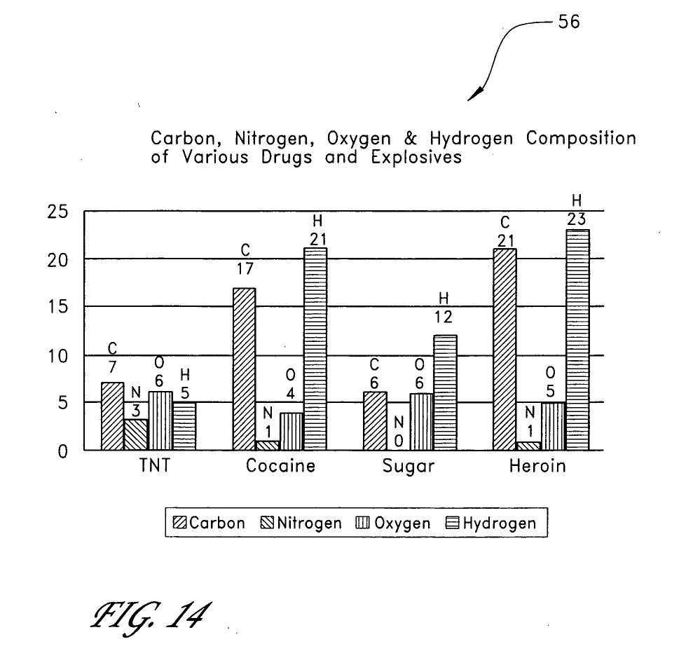

Referring now to FIGS. 9 through 14, an improved gamma ray detection, filtration, and analysis apparatus and method is described. As shown in the Figures, high purity Germanium (Ge) crystal detectors (HPGDs) 26 are used to detect prompt gamma ray emitted from within the test subject. The Germanium detectors provide enhanced gamma energy resolution (on the order of 0.1%) unlike the more common Sodium Iodide detectors (6-10%) typically used in prior art systems, thereby allowing discrimination of the multiple C:N:O or other spectral “lines”. FIG. 9 illustrates a typical gamma spectrum obtained using a prior art NaI detector. Note the breadth of the detected peaks, which is due to the comparatively poor energy resolution of this type of detector. In contrast, the high-resolution gamma spectrum 50 produced from the Ge detectors of the present invention provide greatly enhanced energy resolution, as evidenced by the narrow spectral peaks or lines illustrated in FIGS. 10 and 11. In the present embodiment, the gamma spectrum 50 is electronically converted to a digital representation (FIG. 14) using a conventional analog-to-digital (A/D) converter 31 of the type well know in the electronic arts. Each spectral line 52 is assigned a discrete binary value (“bin”) representing its gamma energy level. Known spectral lines (bins) associated with carbon, nitrogen, and oxygen for the chosen type/energy of incident particle stream are then identified as described in Appendix A and further processed, while other unrelated lines 54 are electronically filtered (using, for example, a conventional digital filter) 33. To digitize the gamma spectral lines, three (3) coincidence circuits are used per each line. Specifically, in one embodiment of the present invention, amplitudes of each of the aforementioned approximately 20 spectral lines associated with C:N:O are determined through analysis of three equal 4 KeV bandwidths within the spectral line; namely, one “peak” bandwidth and two “shoulder” bandwidths (see FIGS. 12a and 12b). The peak-to-shoulder difference(s) are used to determine the amplitude of the peak for purposes of further analysis in the Dalitz plot. As previously discussed, Germanium detectors characteristically have a slower response time than other types of detectors (such as Sodium Iodide crystal), thereby having a correspondingly lower temporal resolution. It is assumed that HPGDs can process a maximum event rate (including random events) on the order of 50,000 counts/sec. This slower response rate is compensated for in the present invention through the use of electronic processing of signals from the detector which effectively varies the response time constant to a lower value. Specifically, in the present embodiment, that portion of the HPGD signal corresponding to a fraction of the rise time of the gamma event is used to determine the time resolution. This rise time is typically in the range of 1.5 to 4 ns, and is measured from a point 10% above the baseline prior to the event to a point 10% below the peak value of the event, as shown in FIG. 13. The rise time signal processing is accomplished via a constant fraction discriminator (CFD) which is well known in the signal processing and nuclear detection arts. Charge collection in the present embodiment is further stopped electronically (“gated”) at 20 ns. Using this arrangement, the effective maximum count rate of the Ge detector is substantially increased, since the detector “dead time” is reduced, and temporal resolution increased.

FIGS. 10 and 11 are exemplary gamma spectra which depict the effect of gating on spectra obtained from a given sample of a chemical compound. FIG. 10 illustrates a gamma spectrum obtained from a urea specimen using a nominal 40 ns gating interval, and background subtraction. Background subtraction is performed in the present embodiment using the method described in Appendix D hereto, with reference to FIG. 12b.

FIG. 11 illustrates a gamma spectrum of the same urea specimen taken using a 5.9 ns gating interval, with no background subtraction (background subtraction is precluded in the spectrum of FIG. 11 due to the narrow gate). When comparing the spectra of FIGS. 10 and 11, it is readily noted that the signal-to-noise ratio (SNR) is significantly enhanced in the spectra of FIG. 11, due primarily to the increased temporal resolution afforded by the shorter gating interval. Hence, an appreciable increase in performance is obtained by using a shorter gating interval, without complex noise suppression or software manipulation.

Experimental data obtained by the applicant herein indicates that counting rate increases on the order of 100% to 400% over non-gated HPGDs are possible when using the techniques described herein. Furthermore, the HPGD of the present invention can meet both requirements for practical contraband detection and identification simultaneously; i.e., high energy resolution and high temporal resolution. Note that while the use of electronic gating at 20 ns herein results in a decrease in energy resolution (i.e., from about 0.1% without gating to about 0.3% with gating), the resultant energy resolution is more than sufficient for the purposes of contraband identification according to the method of the present invention. It will further be recognized that while a CFD performing electronic gating at a nominal interval of 20 ns is used in the present embodiment, other gating intervals, types of circuits, and techniques may be employed to measure and utilize the desired portion of the gamma detector signal.

It is further noted that by using the foregoing filtering and gating techniques, the computational burden on attached signal or data processing equipment is greatly reduced, and more individual gamma detection events can be processed per unit time, since only relevant C:N:O (or other) spectral lines survive the filtration stage and need be correlated with detected alpha particle events. Processing of the resulting spectral signals 56 in real time may be accomplished using any variety of conventional digital signal processing devices such as a “Lookup Table” LeCroy Model 2373 or comparable which provides a high data processing rate.

Appendix E hereto describes the aforementioned gamma detection, selection, and processing utilized by the present invention in additional detail.

Dalitz Triangle

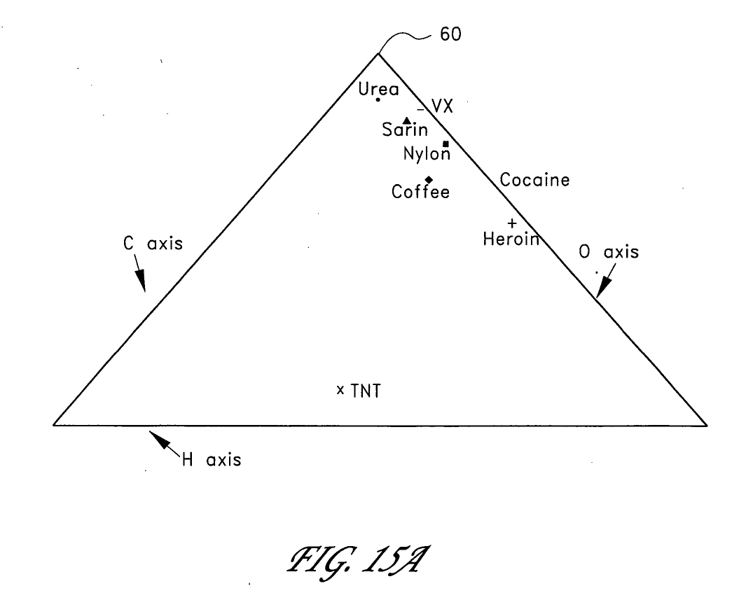

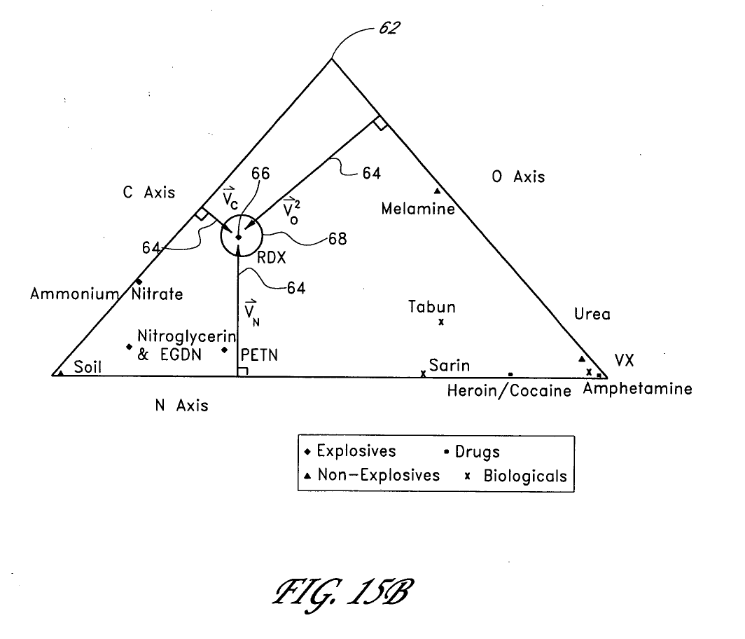

Referring now to FIGS. 15a and 15b, an improved method for identifying chemical compounds using particle activation is described. The filtered digital gamma detector output signal described in the preceding paragraph is input to a signal processing apparatus (such as the aforementioned digital signal processor) running an improved identification/classification algorithm that reduces a three-dimensional problem to a two-dimensional representation. This algorithm is based on the well known “Dalitz Triangle” 60, 62, which correlates the concentrations of three elements within a compound. See Appendix F. Specifically, the length of the normal to each side of the equilateral triangle 60, 62 is proportional to the square of the atomic density of each of the three elements. The algorithm of the present invention takes the filtered digital gamma spectrum 56 which is collected over a given integration interval, computes the relative proportions of the constituent elements based on the binary representations of amplitude of the spectral lines (which correlates to the number of prompt gamma events detected), and mathematically generates a vector 64 normal to the appropriate side of the triangle for each element being analyzed. See FIG. 15b. The point of intersection 66 (or closest point of approach) for all three normal vectors is calculated using well known geometric techniques, thereby defining a single point or range. This point/range is then compared to a “library” of points/ranges associated with various known chemical compounds of interest (such as may be stored in tabular form within a conventional random access memory (RAM)) to identify the compound detected. Subsequent spectra collected from the gamma detectors over a given sample period are then used to statistically increase the confidence level of the identification result. Statistical error bands 68 (such as a given number of standard deviations on a normal or Gaussian distribution) may be used to establish confidence criteria. Such data may also be displayed visually to the system operator, thereby providing him a visual indication of the confidence of a given analysis. For example, the Dalitz triangle may be displayed in graphical form, with the library of known chemical compounds displayed as discrete points within the triangle 60,62. As successive spectra are obtained and analyzed by the system during its integration time, they may displayed as other discrete points on the triangle based on their relative proximity to the library point (compound) of concern. It can be appreciated that a large variety of different display formats (including tables, bar graphs, scatter plots, and the like) may be utilized to convey the desired information, the generation and rendering of all of such formats being well known within the relevant arts.

Auto-Thermal Neutron Activation

An apparatus and method for the simultaneous or sequential application of both thermal and fast neutrons to identify a chemical compound is now described. For the purposes of the present discussion, thermal neutrons are considered to be those neutrons with a total kinetic energy level substantially less than those of fast neutrons. For example, thermal neutrons used in the present invention may have energies on the order of 0.025 eV, while fast neutrons may have energies on the order of 14 MeV as previously described. It will be appreciated that neutrons of multiple energy levels may be present within the object under examination when irradiated by fast neutrons, and that the detection and analysis of quanta emitted as a result of these various neutrons is within the scope of the present invention.

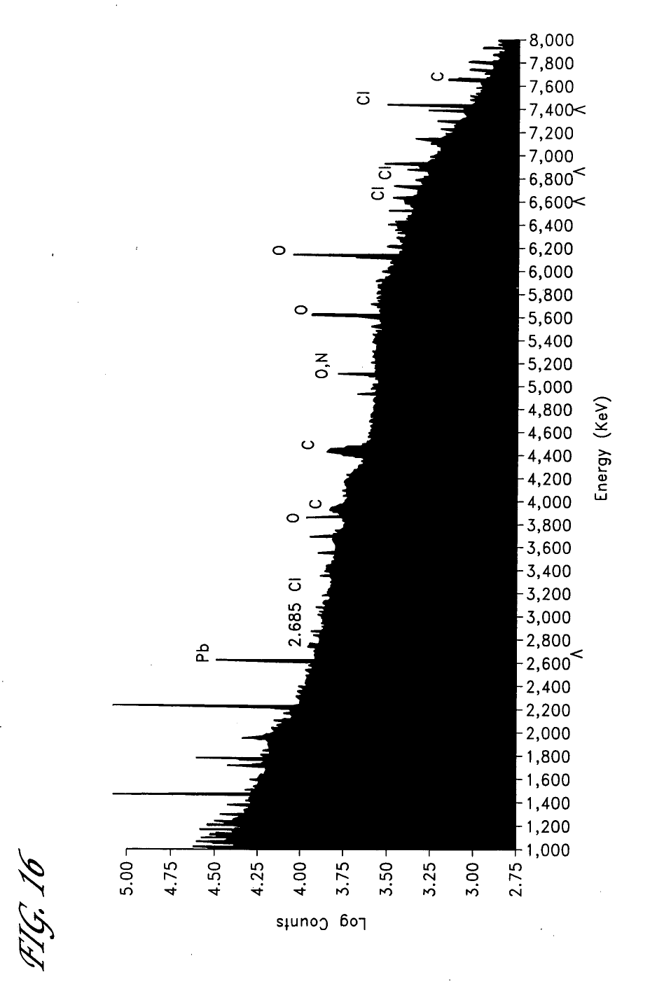

Referring now to FIG. 16, an exemplary gamma ray energy spectrum associated with the cocaine molecule (C₁₇H₂₁NO₄.HCl, also known as cocaine muriate) is shown. Cocaine muriate is a form of cocaine commonly used in the illicit drug trade. The spectrum of FIG. 16 is produced without the coincidence requirement by detecting both prompt gamma rays resulting from the irradiation of the cocaine muriate molecule with fast neutrons as previously described, and the delayed gamma rays from the capture of thermal neutrons in the nuclei. Generally, two primary mechanisms are involved in producing a spectrum such as that of FIG. 16: (i) fast neutron activation of, and subsequent prompt gamma emission from, the carbon, nitrogen, and oxygen atoms within the illicit substance (cocaine muriate in this example); and (ii) thermal neutron activation of other “pointer” atoms present in the illicit substance (here, chlorine), also known as “auto-thermalization”.

Using the apparatus of the present invention described with reference to FIG. 1 above (or other embodiments as described herein), the object suspected of containing illicit substances is irradiated with fast neutrons generated by a neutron source. These incident fast neutrons are moderated or thermalized within the material of the container, within any material surrounding the illicit substance, and by the illicit substance itself. For example, the aforementioned cocaine is often times packed in ordinary rice as a means of confounding detection systems; when an object containing cocaine and sugar is irradiated with fast neutrons, the hydrogen and carbon atoms present in the cocaine and rice slow the fast neutrons to thermal energy levels via multiple inelastic scattering events. The thermalized neutrons subsequently interact with the chlorine atoms in the cocaine, these “pointer” atoms having a comparatively large thermal neutron scattering cross-section of about 33 barns, and produce a series of tell-tale delayed gamma emissions having energy levels centered at approximately 2.69, 6.62, 6.86, and 7.42 MeV as shown in FIG. 16. Note also that in addition to rice, common drug packing substances such as sugar (sucrose) or coffee which are also rich in hydrogen and carbon atoms are also good “auto-moderators” of fast neutrons.

In the apparatus and method of the present invention, the aforementioned tell-tale gamma emissions are detected and counted using the HPGDs and associated scaling circuitry described above, and when a desired statistical confidence level met (e.g., 500 counting events in the selected peak), a signal or “flag” generated to indicate the possible presence of cocaine muriate. The chlorine peak with the highest signal to background ratio (e.g., that occurring at 7.4 MeV) is selected as the flag in the present embodiment, although it will be appreciated that other peaks may be used. Note that the signal to background ratios for the 6.86 and 7.42 MeV peaks are roughly an order of magnitude higher that the ratios obtained from conventional prior art thermal neutron activation systems under the same circumstances (e.g., 2:1 to 3:1, versus 0.2:1 to 0.3:1 for the prior art systems). This roughly ten-fold increase in signal-to-background in the present invention is attributable to the auto-thermalization of fast neutrons within the contraband and its packing material.

In parallel with the foregoing analysis of the gamma spectrum attributable to the chlorine atom, the prompt gamma spectrum resulting from the fast neutron scattering is analyzed as previously described herein. Hence, the gamma spectrum resulting from fast neutron activation is used to refine or confirm the warning signal provided by the thermal neutron induced gamma spectrum. Such confirmation is needed, since arguably many materials of a non-illicit nature contain chlorine atoms as well. Note that no gamma/alpha coincidence or spatial analysis of the thermal neutron induced gamma spectrum is performed in the present embodiment; this facilitates very rapid and simple processing, and allows the warning signal to be generated before the completion of the empirical analysis of the fast neutron induced quanta.

It will be recognized that while the foregoing apparatus and method is described with respect to cocaine muriate and its chlorine atoms, other illicit substances may be analyzed and detected using the present invention. For example, heroin (diacetylmorphine hydrochloride monohydrate, chemical formula C₂₁H₂₃NO₅.HCl.H₂O) includes chlorine atoms which may be used to generate a gamma peak indicative of the possible presence of heroin. Other “pointer” atoms having a substantial thermal neutron cross-section may conceivably be used as well, such as potassium, titanium, vanadium, chromium, manganese, cobalt, silver, cadmium, indium, thallium, tungsten, or mercury. Additionally, while the analysis of the gamma rays resulting from fast neutron activation is preferably performed in parallel or contemporaneously with the thermal neutron gamma analysis, it will be appreciated that such analysis my be sequential or serial in nature, or even performed before the thermal neutron analysis if desired.

It will further be recognized that the foregoing apparatus and method has the advantage of analyzing quanta resulting from thermal neutrons generated within the object under examination, as opposed to predominantly incident thermal neutrons as used in prior art neutron activation systems. In these prior art systems, fast neutrons are typically made to hit a moderator (usually water or paraffin) near the target where they are thermalized and lose directional orientation. As a result, the thermal neutron flux emitted from the moderator toward the object under examination is only a small fraction of the fast neutron flux incident on the moderator. This effect greatly reduces the net gamma flux out of the object being examined, thereby reducing counting rate and system efficiency. Note that in such prior art systems, a small fraction of fast neutrons incident on the moderator may escape the moderator without being thermalized, and therefore may go on to be thermalized within the object under examination. This is in contrast to the invention disclosed herein, in which effectively all thermalizations occur within the object under examination.

Additionally, the penetration depth of the fast neutrons used in the present invention is greatly enhanced (on the order of 1 meter), as compared to the typical penetration depth (roughly 2-3 cm) for incident thermal neutrons. This increased penetration depth is important to the efficacy of the system, since most contraband is secreted within other objects which often times have significant mass and density, thereby significantly attenuating thermal neutrons within a very short distance long before they hit the contraband. Furthermore, because only a small fraction of incident thermal neutrons might reach the hidden contraband when using one of the aforementioned prior art systems, the resulting gamma flux out of the object under examination is accordingly small, thereby necessitating either a very high incident thermal neutron flux, or a very long counting/integration time.

System Calibration and “Figure of Merit”

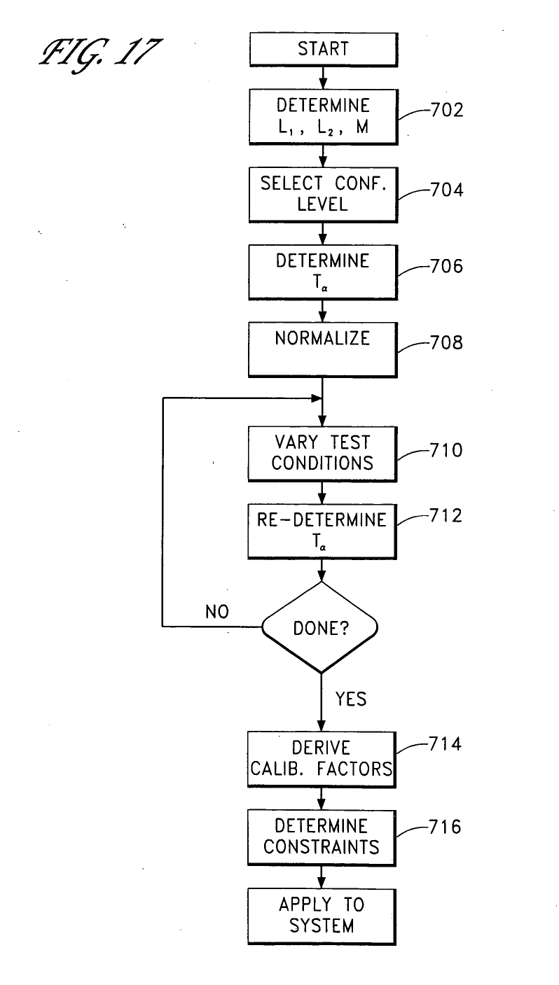

An improved method for measuring the efficacy (“figure of merit”) of a particle activation-based detection/analysis system and calibrating same is now described. Referring now to FIG. 17, a discovery time constant (Td) is mathematically defined as follows:

$${T}_{d} = C \frac{{L}_{1}^{2} \times {L}_{2}^{2}}{M} \qquad ( Eqn . 2 )$$

Where:
T_{d}=Disc. Time Constant (s)
L₁=Target−Chemical Dist. (m)
L₂=2 Detect−Chemical Dist (m)
M=Mass of Chemical (Kg)
   Note that the quantities L1 and L2 are squared due to the solid angles subtended by the system detectors. This time constant is a measure of the time required to perform a chemically specific identification of a certain mass of chemical compound at a certain distance from the particle source (target), and certain distance between the chemical compound and gamma detector(s), with a prescribed statistical confidence level about the relevant point on the aforementioned Dalitz triangle 60,62. In practice of this method 700, the relevant distances to the chemical compound and detector(s) are measured or calculated, and the mass M determined as shown in step 702 of FIG. 17. Next, the desired confidence level is selected in step 704. This confidence level is mathematically determined through statistical analysis of the spectral data produced on successive operation of the system during a given testing interval, as previously described. The known mass of a given chemical compound is then analyzed in step 706, thereby experimentally determining T_{d} for this set of constraints. Next, in step 708, the time constant is optionally normalized. For example, the system may require 5 seconds to identify a 1 kg sample compound to a 95% level of confidence at a detector/sample distance of 1 meter in dry air at STP; this nominal or “baseline” value may be normalized to 1 second if desired. In steps 710 and 712, the mass and/or environmental test factors (such as location of the mass, relative humidity, etc.) are varied and the discovery time again measured under these new conditions. These steps 710, 712 may be repeated a number of times when, for example, incrementally varying one parameter, or varying many parameters at once, as described further below. Next, correction or calibration factors are calculated for the system in step 714. For example, if the system was normalized using a 1 kg mass in dry air at STP, operation of the system in humid air at lower temperature (assuming comparable mass and detector geometry) would produce a higher value of T_{d}. This higher value of T_{d} is then ratioed with the nominal T_{d} to produce a correction factor for operation of the system in humid/low temperature environments. Tables or curves may also be constructed detailing the response of the system as a function of varying system parameters and test conditions, or salient combinations of parameters. Lastly, other critical system constants, including 1) the rate of system “false positives”, and 2) the rate of “false negatives” (e.g., missed detections/identifications where an actual compound of interest was present) are experimentally determined and correlated to the confidence level previously described in step 716. For example, if the false positive rate increases substantially below a confidence level of 90%, this value is used as a minimum threshold for system operation. The T_{d} value necessary to achieve this confidence level or higher is then specified as the minimum operating time for the system when examining objects or areas.

In addition to the foregoing uses relating to calibration and field operation, experimentally generated values of T_{d} for one system (under a certain range of specified test conditions) may also be compared to those generated for another system in order to determine the relative efficacy (merit) of the two systems at chemical identification and location. This method is very useful in standardizing the comparison of two systems of differing operating principle; at present, no system of comparison exists, hence manufacturer's claims of performance can not be directly compared. Such “figures of merit” may be developed as a function of various critical parameters (such as ambient temperature, humidity, interposed shielding, etc.) to assist in determining the best instrument/technique (or combination thereof) to apply in a given testing or field application.

While the above detailed description has shown, described, and pointed out the fundamental novel features of the invention as applied to various embodiments, it will be understood that various omissions, substitutions, and changes in the form and details of the devices or processes illustrated may be made by those skilled in the art without departing from the spirit or essential characteristics of the invention. The described embodiments are to be considered in all respects only illustrative and not restrictive. The scope of the invention is, therefore, indicated by the appended claims rather than the foregoing description. All changes that come within the meaning and range of equivalence of the claims are to be embraced within their scope.

### Appendix A

A.1 Gamma Energy.

The gamma energy peaks produced during the inelastic collision between fast neutrons and various atomic nuclei have a typical energy range of 0.100 to 18 MeV. The general contention in explosive detection has always been to detect the major components of explosives; that is, carbon, nitrogen, and oxygen. Therefore, the following discussion will focus on the gamma ray spectra of these constituent elements. It should be noted, however, that this principal is potentially applicable to many other elements including chlorine, phosphorus, and sulfur.

Size and efficiency limitations of HPGDs limit the upper range of detectable gamma energies. For example, based on laboratory measurements with at 45% efficient N-type HPGD, a ceiling of 5.5-6.2 MeV prohibited the use of any gamma peaks about 6.129 MeV. The gamma energy peak selection process was therefore limited to gamma counts emanating below 6.2 MeV. The 5.104 photo-peak of nitrogen produced 49 counts±14 using this detector. In comparison, an 81% N-type detector produced an energy ceiling of 7 MeV, with the equivalent 5.104 nitrogen photo-peak (using equivalent neutrons) producing 197 counts±21.

While detector efficiency and size limits the ceiling of measured gamma peaks, the absorption of gamma rays through various materials influences the floor. Gamma attenuation is proportional to the thickness (Z) of interrogated materials. Further, based on measurements from experimental data of soil measurements, gamma rays below 1.6 MeV cannot be used for this application. Hence, the floor for gamma peak selection is at least in part based on the identity of interrogated material, and is on the order of 1.6±0.5 MeV for most applications.

A.2 Cross Section

After the determination of the gamma energy range, one must decide which gamma rays within the 1.6 to 7.2 MeV are to be used for analysis. One of the main factors for this selection process is atomic cross section.

The probability of inducing a specific gamma ray depends on the binding forces within the nucleus of each atom. This probability is the atomic cross section or size (effective) for the production of gamma rays and is measured in barns (10⁻²⁴ cm). Established cross sections for carbon, nitrogen, and oxygen are used to establish a ratio between the number of carbon, nitrogen, and oxygen atoms.

Carbon is somewhat unique with respect to the present analysis. First, carbon has a relatively simple gamma decay structure—there is only one detectable photo-peak (4.440 MeV) from 1.6 to 7.2 MeV. Second, the cross section of the 4.440 MeV peak (14 MeV incident neutrons) is 210.6 mb (very large). Third, the cross section of the 4.440 MeV peak increases dramatically as neutrons thermalize—8 MeV incident neutrons have a cross section of 445 mb. The simple nature of the carbon decay scheme therefore translates the 4.440 MeV photo-peak to the ubiquitous carbon marker. However, the simple spectra of carbon has a consequence; because of the nature of the carbon nucleus, there is a recoil during the inelastic collision which produces a short-lived energy state. Subsequently, the photo-peak is rather wide with a shift of ±50 KeV. Thus, in order to obtain an accurate determination of carbon atoms, detection from 4.340 to 4.540 MeV is needed.

Nitrogen and oxygen have many photo-peaks from 1.6 to 7.2 MeV. The cross-section of the oxygen photo-peak at 6.129 MeV is 101 mb. Nitrogen has three detectable photo-peaks at 2.312, 3.948, and 5.104 MeV with cross sections of 7.8, 3.5, and 31 mb, respectively. The minimum detectable cross section of a photo-peak is 5 mb (cascades often increase the observable cross section of photo-peaks, see section A.3 below).

A.3 Cascade vs. Photo-Peak

In addition to traditional energy levels, cascade effects increase the number of possible energy peaks. Cascade effects are excitations of energy level that are not sufficient enough to cause a direct drop to the lowest energy state; and as a result, cascade peaks are produced from the systematic drop of photons from excited energy states to more stable ones. For example, the 2.748 MeV oxygen cascade is produced by the excitation of the 8.872 MeV photo-peak and its subsequent drop to the 6.129 MeV energy level. The photon then drops from the 6.129 MeV (second photo-peak) to the ground state. In effect, the excitation of higher energy levels produce more gamma energy peaks and hence a greater probability of detection.

Unfortunately, data for cascade cross sections are not readily available. Experimental results have yielded approximate cross sections based on normalization to photo-peaks with detector efficiency and gamma absorption corrections. For oxygen, a normalized spectra of H₂O elucidated an approximate cascade cross section of 28 mb for the 2.748 MeV peak.

Cascade peaks represent over 50% of the total spectrum for oxygen and nitrogen. In order to maximize count rate, it is prudent to utilize cascade peaks to avoid the problems addressed by gamma energies outside the 1.6 to 7.2 MeV range, avoid the use of low cross section peaks, and finally circumvent the problem of proximity and overlap.

A.4 Proximity and Overlap

One of the most important factors in atometric analysis is proximity and overlap of gamma ray peaks. Proximity of gamma ray peaks is the simpler of the two cases. One of the advantages of using HPGe detectors is its increased resolution (on the order of 0.1%) at 622 KeV. For instance, a HPGe detector can discriminate between a 5.156 MeV aluminum signal from a 5.104 MeV nitrogen signal. NaI detectors have resolution of roughly 10% at 722 KeV and cannot discern between many peaks in the spectrum. Proximity is an indication of the increased resolving power of the HPGD and is treated as an important tool for discrimination.

Overlap is the extreme case of proximity. An example of overlap is witnessed in the carbon 4.440 MeV peak (recall the width of the peak is 100 KeV). Therefore, any gamma peak in this range of the spectrum would contribute to error in the carbon signal. The worst case is overlap by elements other than nitrogen and oxygen. Note that Aluminum has a photo-peak with a cross section of 4.9 mb at 4.411 MeV.

It is important to use information from the entire spectrum to scan for possible overlap and eliminate it by subtraction. If the overlap is between the three constituent elements, an appropriate algorithm may readily be developed to subtract extraneous counts. In conclusion, proximity and overlap determine the most ‘opportune’ gamma signals for use in the analysis.

A.5 Single/Double Escape Peaks

Another important factor in determining which gamma energies are used for analysis is the production of single and double escape peaks. Pair production is the result of electron/positron annihilation with the concomitant release of 511 KeV (0.5 MeV) quanta in roughly opposite directions. This process occurs in the matrix of the crystal lattice and is a function of the detector size.

The most prominent single escape peak is from the oxygen 6.129 MeV peak. One sharp peak is produced 0.511 MeV lower at 5.618 MeV. A second escape peak is also produced 1.022 MeV downstream at 5.107 MeV. Coincidentally, the nitrogen photo-peak at 5.104-5.107 peak is greater in intensity than the 5.618 MeV peak; this is a clear indication that there is a signal from nitrogen as well as oxygen.

To eliminate the second oxygen escape peak from the nitrogen peak, one must determine the effective cross section of the escape peaks (specific to the chosen detector only). Based on experimental results of SiO₂ trials by Applicant, the cross section of the first and double escape peaks are 70% and 31% of the 6.129 MeV peak. In other words, the net number of counts in the 5.107 MeV double escape, contributed from oxygen at 6.129 MeV, is 31% of net counts in 6.129 MeV oxygen photo-peak.

### Appendix B

B.1 Elimination of Noise

A significant obstacle for quantitative atometry is the elimination of extraneous noise. N may arise from a variety of sources including air surrounding the test specimen and apparatus; in one m³ of air, there is 925 grams of nitrogen and substantial oxygen.

Accordingly, a method of dealing with this “noise” is needed. First, one must determine the volume of air interrogated by tagged neutrons. To accomplish this, a hypothetical rectangular box is used to represent the volume of interrogated air. For more precise measurements, one may replace the rectangle by a cone, to account for the drift of neutrons from the source. But for this investigation, the difference in volume is insignificant next to the size of the sample and an approximation with a rectangular volume will suffice.

To determine exactly how much nitrogen and oxygen contribute to the data, it is necessary to calculate the dimensions of the rectangle. In one exemplary trial, the coincidence gate was open for a duration of 6.8 ns or roughly 34.5 cm centered on the target (neutron velocity is 5 cm per nanosecond). Since the target was exactly 1 meter away, the length of rectangle is 34.5 cm—+/−17 cm from the target. The area of the rectangle is a function of the alpha detector size. The alpha detector for this series of experiments had a measured area of 44.15 cm². The area of tagged neutrons, at 1 meter is exactly 4415 cm². Therefore, the total volume of interrogated air is [4415 cm²×34.5 cm=152,000 cm³).

The average density of dry air at room temperature is assumed to be ρ=0.00121 g/cm³. As a result, it is possible to determine the mass of air [0.00121 g/cm³×152,000=178 g]. Since the mass of the urea test sample is also known (5 kg in the present example) it is also possible to calculate the ratio of “moles of sample” to “moles of noise” (molecular weight of air ˜29/gmole and urea 60.1 g/mole); specifically 6.87%.

Finally, to determine the number of nitrogen and oxygen counts as a result of the air, the following formula was used (based on nitrogen):
Percent nitrogen=(moles nitrogenₐᵢᵣ)/(moles nitrogenₐᵢᵣ+moles nitrogenᵤᵣₑₐ)×100% (Eqn. B.1)
Equation B.1 yields a correction value of 5.36% for nitrogen and 1.44% for oxygen. In other words, the net peak counts have to be corrected to account for extraneous signals from nitrogen and oxygen in air.

It should be noted that the identity of each gamma line, to this point, has not been of consequence. However, based on the discussion in Appendix A above, any gamma line that corresponds to an overlap with an escape peak must be treated with special care. The nitrogen 5.104 peak is this exception. An additional correction factor is required to calculate the percentage of oxygen (double escapes) that overlap with this signal

### Appendix C

C.1 Correction for Detector Efficiency

The concept of relative detector efficiency (i.e., that efficiency relative to a particular chosen energy value) is introduced herein. One of the reasons to use relative efficiency in the present invention instead of absolute efficiency is that only a quantitative atometric ratio of elements is needed, and not atomic content from one species outright. For instance, one does not have to solve implicitly for n (atomic density). Instead, if the ratio of atomic density is used, one may set C:N:O equal to the ratio of n₁ to n₂ where the detector efficiencies are relative to each other. Table C.1 lists experimental numerical values of the relative efficiency of a 80% N-type HPGe.

TABLE C.I

| Detector | 80% | Relative to |
|---|---|---|
| Emergy (KeV) | Efficiency | 2300 KeV |
| 1800 | 6.91E+01 | 0.14 |
| 2300 | 6.02E+01 | 1.00 |
| 4440 | 4.15E+01 | 1.46 |
| 5105 | 3.84E+01 | 1.57 |
| 6129 | 3.46E+01 | 1.74 |

It should be noted that relative efficiency in Table C.1 is based on the 2,3000 KeV value. For example, the ratio of relative intensity increases 45% from 2,300 KeV to 4,400 KeV and 9% from 4,400 KeV to 5,100 KeV.

### Appendix D

D.1 Background Subtraction—General

It is evident that in order to quantitatively discern atomic information from gamma peaks, a method and algorithm for background subtraction be devised. The Regions of Interest (“ROI”) for background subtraction depend on the identity of the interrogated material. In the case of explosives and drugs, these regions must overlap with the specific gamma signature lines of carbon, nitrogen and oxygen. A detailed list of gamma lines, escape peaks and cascades has been determined by the Applicant herein.

D.2 Method

First, the background on the upstream (lower energy) side of the peak is calculated as the average of the first three channels of the ROI. The channel number for this background point is the middle channel of the three points. Background on the downstream (higher energy) channel side of the peak is calculated as the average of the last three channels of the ROI. The channel number for this background point is also the middle channel of these latter three points. The two background points on each side of the peak form the end points of the straight-line background. Hence, the background is given by the following:

$$B = ( {\sum }_{i = 1}^{l + 2} {C}_{i} + {\sum }_{i = h - 2}^{h} {C}_{i} ) \frac{h - l + 1}{6} \qquad ( Eqn . D .1 )$$

where
B=the background area
I=the ROI low limit
h=the ROI high limit
Cᵢ=the contents of channel i
6=the number of data channels used (3 on each side in the present embodiment)
The gross area (counts) is the sum of all the channels contained within the ROI according to the following:

$${A}_{g} = {\sum }_{i = l}^{h} {C}_{i} \qquad ( Eqn . D .2 )$$

where
A_{g}=the gross counts in the ROI
l=the ROI low limit
h=the ROI high limit
Cᵢ=contents of channel I
The adjusted gross area is the sum of all of the channels within the ROI but not used in the background according to the following:

$${A}_{ag} = {\sum }_{i = l + 3}^{h - 3} {C}_{i} \qquad ( Eqn . D .3 )$$

where
A_{ag}=the gross counts in the ROI
l=the ROI low limit
h=the ROI high limit
Cᵢ=contents of channel I

$${A}_{n} = {A}_{ag} - \frac{B ( h - l - 5 )}{( h - l + 1 )} \qquad ( Eqn . D .4 )$$

The error in the net adjusted area is the square root of the sum of the squares of the error in the adjusted gross area and the weighted error of the adjusted background. The background error is weighted by the ration of the adjusted peak width to the number of the channels used to calculate the adjusted background.

### Appendix E

The following describes the overall method of the atometric process of the present invention.

First, gamma information is gathered using an average value of peak width, location, and energy (Appendix A). Next, the gamma lines are systematically chosen for background subtraction (Appendix D). Each gamma line is subjected to numerous fitting routines until the lowest error value is repeated. Finally, corrections are made for extraneous noise, detector efficiency, and gamma attenuation (Appendix C).

In order to ascertain the empirical formula for any contraband substance, the aforementioned data for one element are related to the number of gamma counts of another—such as carbon to oxygen—from the following established formula:
I_{γ=}F.(δΩ).σ.n.V.Γ_{eff}.γ_{abs}.v_{abs} (Eqn. E.1)
Here, I_{γ}=the gamma intensity=net gamma counts for specific energy range as calculated by background subtraction with the ROI algorithm. I_{γ} is standardized to a set number of channels; carbon=100, nitrogen and oxygen=12. δ_{eff}, γ_{abs} and v_{abs} are detector efficiency, gamma and neutron attenuation factors, respectively, and σ is the cross section. Here, Γ_{eff} includes solid angle subtended by the detector at 0.25 m (according to the relevant IEEE standard).

The number of neutrons was calculated using the ratio of alpha to neutron counting rate:

$$F = \frac{α}{sec} . sec . \frac{130 neutrons}{α} = \# neutrons \qquad ( Eqn . E .2 )$$

F=neutron flux (number of neutrons into 4π).
(δΩ)=[π(D²/4)]/(4π²)=D²/16L²) (Eqn. E.3)
(δΩ)=Solid r of object and L is distance from neutron source of the object. The number of atoms exposed to neutrons is:

$$\# atoms = n . V = ( \frac{atoms}{{cm}^{3}} ) ( \frac{Volume}{1} ) \qquad ( Eqn . E .4 )$$

In this case, n=atomic density; and V=volume. And the cross product of atomic density and volume is atoms (n).

Since atometric information is required from different elements in the same trial, it is possible to cancel out common factors. F, (δΩ), and V_{abs}. Equation E.1 may be rewritten to cancel out factors in the following form:
I_{γ}=σ.n.Γ_{eff}.γₐₜₜ (Eqn. E.5)
Finally, Equation E.5 can be solved for n.

$${n}_{atoms} = \frac{⌊ {I}_{γ} ⌋}{[ σ . {Γ}_{eff} . \frac{1}{{γ}_{att}} ]} \qquad ( Eqn . E .6 )$$

Determination of the C:N:O ratio is based on Equation E.6. γₐₜₜₑₙ is a reciprocal because its effects decrease gamma value below 2,300 KeV and increase values above 2,300 KeV. E.6 may be written as follows:

$${n}_{atoms} = \frac{⌊ {I}_{γ} . {γ}_{att} ⌋}{[ σ . {Γ}_{eff} ]} \qquad ( Eqn . E .7 )$$

In order to solve of n₁, the noise-, efficiency-, and attenuation-corrected values (plus cross sections for carbon, nitrogen) may be used. For example,

$$\begin{matrix}\begin{matrix}{n}_{nitrogen} = ( 76.5 \times 1.57 ) / ( 32 \times 1.31 ) \\ = 2.06\end{matrix} \\ similarly , & ( Eqn . E .8 ) \\ \begin{matrix}{n}_{carbon} = ( 256 \times 1.24 ) / ( 210.6 \times 1.24 ) \\ = 1.04\end{matrix} \\ finally , & ( Eqn . E .9 ) \\ \begin{matrix}{n}_{oxygen} = ( 127 \times 1.41 ) / ( 101 \times 1.74 ) \\ = 1.02\end{matrix} & ( Eqn . E .10 )\end{matrix}$$

To reduce the atomic data into the empirical chemical formula, the atomic ratios are divided by the lowest value (1.02) for oxygen. The complete empirical formula for urea is:
C (1.04/1.02)=1 (Eqn. E.11)
N (2.06/1.02)=2.02 (Eqn. E.12)
O (1.02/1.02)=1 (Eqn. E.13)
By using the error values for the peak fitting algorithm and propagation of error, the complete formula of urea with error is as follows:
C_{1(±09)}N_{2.02(±0.21)}O_{1(±0.48)} (Eqn. E.14)

### Appendix F

As previously described, the Dalitz Plot (or “A-plot”) is a two dimensional graphical representation of three dimensions of information; namely, the carbon, nitrogen and oxygen ratio of explosives and other contraband. See FIGS. 15a and 15b above. For example, the A-plot is a normalized atomic density for nitrogen, N′=N/(C+N+O), obtained from the gamma detectors, and represented by the perpendicular distance-squared from the horizontal side of the equilateral triangle. Similarly, the normalized atomic densities of carbon, C′, and oxygen, O′, are represented by perpendicular distances-squared from the other two sides of the triangle. This information may easily be translated into an A-plot by the following steps (using urea as an example):
Experimentally determined empirical formula=C₁N_{2.02}O₁
Carbon=1
Nitrogen=2.02
Oxygen=1
Total=4.02
   Partial Fraction C¹=C/(C+N+O) (Eqn. F.1)
C′=0.248
N′=0.502
O′=248
   Square of Partial Fraction:
   C′⁽²⁾=0.0618
   N′⁽²⁾=0.252
   O′⁽²⁾=0.0618 (Eqn. F.2)
   Sum of Squares (h²):
   h²=0.376 (Eqn. F.3)
   Square of each element over square of total=Yₓ:
   Y_{c}=C²/C²+N²+O²=0.164
   Yₙ=0.671
   Y_{O}=0.164 (Eqn. F.4)
   Normalized square length=L_{c}:
   L_{c}=C′⁽²⁾/h²=0.164
   Lₙ=0.671
   Lₒ=0.164 (Eqn. F.5)
   X and Y values of urea [107] in Dalitz Plot:
   X=0.577350*(Yₙ+(2Y_{c}))=0.57735
   Y=Lₙ=0.671 (Eqn. F.6)
   Therefore, the boundaries of Dalitz Plot are:
   (0,0) (Eqn. F.7)
   (0.57735,1) (Eqn. F.8)
   (1.1547,0) (Eqn. F.9)

What is claimed is:

1. A method of providing non-invasive, stoichiometric analysis and imaging of a substance through a barrier, the substance comprising atomic nuclei which emit one or more gamma rays in response to neutron irradiation, the gamma rays having energies characteristic of the atomic nuclei, the method comprising:
emitting a plurality of neutron/alpha particle pairs from a location separate from the substance, each pair comprising a neutron having an energy of approximately 14 MeV and a corresponding alpha particle, the neutron and the alpha particle of each pair propagating in substantially opposite directions;
detecting alpha particles propagating from the location in a direction generally away from the substance;
irradiating a region of the substance with neutrons emitted from the location, the neutrons propagating through the barrier and interacting with atomic nuclei in the region to emit a first plurality of gamma rays from the region through the barrier and to produce a plurality of thermal neutrons in the region, the thermal neutrons interacting with atomic nuclei in the region to emit a second plurality of gamma rays from the region through the barrier;
generating a first plurality of gamma detection signals corresponding to a detected portion of the first plurality of gamma rays detected by a solid-state photon detector having an energy resolution less than or equal to approximately 0.5%;
generating a second plurality of gamma detection signals corresponding to a detected portion of the second plurality of gamma rays detected by the solid-state photon detector;
selecting one or more energies characteristic of at least one of the atomic nuclei of the substance;
energy-filtering the first plurality of gamma detection signals to generate a first plurality of energy-filtered gamma signals by passing gamma detection signals corresponding to detected gamma rays having the selected energies and by rejecting gamma detection signals corresponding to detected gamma rays not having the selected energies;
detecting coincidences between the first plurality of energy-filtered gamma signals and the detected alpha particles; and
energy-filtering the second plurality of gamma detection signals to generate a second plurality of energy-filtered gamma signals by passing gamma detection signals corresponding to detected gamma rays having the selected energies and by rejecting gamma detection signals corresponding to detected gamma rays not having the selected energies.

2. The method of claim 1, further comprising using the detected coincidences to generate an image of the substance.

3. The method of claim 1, wherein energy-filtering the second plurality of gamma detection signals is performed substantially simultaneously with energy-filtering the first plurality of gamma detection signals.

4. The method of claim 1, wherein energy-filtering the second plurality of gamma detection signals is performed before energy-filtering the first plurality of gamma detection signals.

5. The method of claim 1, wherein the substance comprises a nitrogen-containing explosive material and the selected energies comprise energies characteristic of nitrogen nuclei.

6. The method of claim 5, wherein the selected energies further comprise energies characteristic of oxygen nuclei.

7. The method of claim 6, wherein the selected energies further comprise energies characteristic of carbon nuclei.

8. The method of claim 5, wherein the selected energies further comprise energies characteristic of carbon nuclei.

9. The method of claim 1, wherein the substance comprises a chlorine-containing material and the selected energies comprise energies characteristic of chlorine nuclei.

10. The method of claim 1, wherein the substance comprises a hydrogen-containing material and the selected energies comprise energies characteristic of hydrogen nuclei.

11. The method of claim 1, wherein the substance comprises a sulfer-containing material and the selected energies comprise energies characteristic of sulfer nuclei.

12. The method of claim 1, wherein the barrier comprises steel.

13. The method of claim 1, wherein the neutron/alpha particle pairs are generated in a non-pulsed direct-current mode.

14. The method of claim 1, wherein the solid-state photon detector has an energy resolution of approximately 0.3%.

15. The method of claim 1, wherein the solid-state photon detector has an energy resolution on the order of 0.1%.

16. The method of claim 1, wherein the detected gamma rays have energies between 1.6 MeV and 7.2 MeV.

17. The method of claim 1, further comprising using the second plurality of energy-filtered gamma signals to calculate one or more stoichiometric atomic ratios of the atomic nuclei present in the substance.

18. The method of claim 17, wherein the stoichiometric atomic ratios comprise one or more of the nitrogen-to-oxygen stoichiometric atomic ratio, the nitrogen-to-carbon stoichiometric atomic ratio, and the carbon-to-oxygen stoichiometric atomic ratio.

19. The method of claim 17, further comprising identifying the substance from the one or more stoichiometric atomic ratios.

20. The method of claim 17, further comprising determining an empirical chemical formula of the substance from the one or more stoichiometric atomic ratios.

21. The method of claim 1, wherein generating the first plurality of gamma detection signals comprises processing the first plurality of gamma detection signals using a constant fraction discriminator and electronically gating the first plurality of gamma detection signals.

22. The method of claim 1, wherein generating the second plurality of gamma detection signals comprises processing the second plurality of gamma detection signals using a constant fraction discriminator and electronically gating the second plurality of gamma detection signals.

23. A method of providing non-invasive, stoichiometric analysis and imaging of a substance, the substance comprising atomic nuclei which emit one or more gamma rays in response to neutron irradiation, the gamma rays having energies characteristic of the atomic nuclei, the method comprising:
irradiating the substance with 14-MeV neutrons generated in neutron/alpha particle pairs, each pair comprising a 14-MeV neutron and an alpha particle propagating in a substantially opposite direction to the neutron, wherein said irradiation generates thermal neutrons within the substance;
detecting at least a portion of the alpha particles from the neutron/alpha particle pairs, the detected alpha particles propagating in a direction generally away from the substance;
generating a first plurality of gamma detection signals corresponding to a detected portion of a first plurality of gamma rays generated by interactions of the 14-MeV neutrons with atomic nuclei in the substance, the detected portion of the first plurality of gamma rays detected with an energy resolution less than or equal to approximately 0.5%;
generating a second plurality of gamma detection signals corresponding to a detected portion of a second plurality of gamma rays generated by interactions of the thermal neutrons with atomic nuclei in the substance, the detected portion of the second plurality of gamma rays detected with an energy resolution less than or equal to approximately 0.5%;
selecting one or more energies characteristic of at least one of the atomic nuclei of the substance;
energy-filtering the first plurality of gamma detection signals to generate a first plurality of energy-filtered gamma signals by passing gamma detection signals corresponding to detected gamma rays having the selected energies and by rejecting gamma detection signals corresponding to detected gamma rays not having the selected energies;
detecting coincidences between the first plurality of energy-filtered gamma signals and the detected alpha particles; and
energy-filtering the second plurality of gamma detection signals to generate a second plurality of energy-filtered gamma signals by passing gamma detection signals corresponding to detected gamma rays having the selected energies and by rejecting gamma detection signals corresponding to detected gamma rays not having the selected energies.

24. A method of providing non-invasive, stoichiometric analysis and imaging of a substance, the substance comprising atomic nuclei which emit one or more gamma rays in response to neutron irradiation, the gamma rays having energies characteristic of the atomic nuclei, the method comprising:
irradiating the substance with non-thermal neutrons generated in neutron/alpha particle pairs, each pair comprising a non-thermal neutron and an alpha particle propagating in a substantially opposite direction to the neutron, wherein said irradiation generates thermal neutrons within the substance;
detecting at least a portion of the alpha particles from the neutron/alpha particle pairs, the detected alpha particles propagating in a direction generally away from the substance;
generating a first plurality of gamma detection signals corresponding to gamma rays generated by interactions of the non-thermal neutrons with atomic nuclei in the substance, the first plurality of gamma detection signals having an energy resolution less than or equal to approximately 0.5%;
generating a second plurality of gamma detection signals corresponding to gamma rays generated by interactions of the thermal neutrons with atomic nuclei in the substance, the second plurality of gamma detection signals having an energy resolution less than or equal to approximately 0.5%;
energy-filtering the first plurality of gamma detection signals to generate a first plurality of energy-filtered gamma signals by passing gamma detection signals corresponding to energies characteristic of at least one of the atomic nuclei of the substance and by rejecting gamma detection signals corresponding to energies which are not characteristic of at least one of the atomic nuclei of the substance;
detecting coincidences between the first plurality of energy-filtered gamma signals and the detected alpha particles; and
energy-filtering the second plurality of gamma detection signals to generate a second plurality of energy-filtered gamma signals by passing gamma detection signals corresponding to energies characteristic of at least one of the atomic nuclei of the substance and by rejecting gamma detection signals corresponding to energies which are not characteristic of at least one of the atomic nuclei of the substance.

25. A method of providing non-invasive, stoichiometric analysis and imaging of a substance through a barrier, the substance comprising atomic nuclei which emit one or more gamma rays in response to neutron irradiation, the gamma rays having energies characteristic of the atomic nuclei, the method comprising:
emitting a plurality of neutron/alpha particle pairs from a location separate from the substance, each pair comprising a neutron having an energy of approximately 14 MeV and a corresponding alpha particle, the neutron and the alpha particle of each pair propagating in substantially opposite directions;
detecting alpha particles propagating from the location in a direction generally away from the substance;
irradiating a region of the substance with neutrons emitted from the location, the neutrons propagating through the barrier and interacting with atomic nuclei in the region to emit a first plurality of gamma rays from the region through the barrier and to produce a plurality of thermal neutrons in the region, the thermal neutrons interacting with atomic nuclei in the region to emit a second plurality of gamma rays from the region through the barrier;
generating a first plurality of gamma detection signals corresponding to a detected portion of the first plurality of gamma rays;
generating a second plurality of gamma detection signals corresponding to a detected portion of the second plurality of gamma rays;
selecting a set of one or more energies characteristic of at least one of the atomic nuclei of the substance;
energy-filtering the first plurality of gamma detection signals to generate a first plurality of energy-filtered gamma signals by passing gamma detection signals corresponding to detected gamma rays with energies within the set of energies and by rejecting gamma detection signals corresponding to detected gamma rays with energies not within the set of energies;
detecting coincidences between the first plurality of energy-filtered gamma signals and the detected alpha particles; and
energy-filtering the second plurality of gamma detection signals to generate a second plurality of energy-filtered gamma signals by passing gamma detection signals corresponding to detected gamma rays with energies within the set of energies and by rejecting gamma detection signals corresponding to detected gamma rays with energies not within the set of energies.
